(19) United States
(12) Patent Application Publication
(10) Pub. No.: US 2009/0147705 A1
(43) Pub. Date: Jun. 11, 2009

(54) METHOD FOR DETERMINING AT LEAST ONE USER TERMINAL FOR A TELECOMMUNICATION CONFERENCE SESSION, TELECOMMUNICATION CONFERENCE ARRANGEMENT AND TELECOMMUNICATION CONFERENCE SESSION SERVER

(75) Inventor: Frank Kowalewski, Unterhaching (DE)

Correspondence Address: Viering, Jentschura & Partner, 3770 Highland Ave., Suite 203, Manhattan Beach, CA, 90266, US

(73) Assignee: INFINEON TECHNOLOGIES AG, Neubiberg (DE)

(21) Appl. No.: 12/328,803

(22) Filed: Dec. 5, 2008

(30) Foreign Application Priority Data
Dec. 7, 2007 (DE) 102007058948.6

(51) Int. Cl. H04Q 11/00

(52) U.S. Cl. 370/261

(57) ABSTRACT

In a method for determining at least one user terminal for a telecommunication conference session with a multiplicity of telecommunication conference session user terminals, wherein a predefined telecommunication conference session participation condition is allocated to the at least one telecommunication conference session user terminal, the predefined telecommunication conference session participation condition may be checked by involving two telecommunication conference session servers. A first telecommunication conference session server receives an enquiry for determining at least one user terminal for a telecommunication conference session and a second telecommunication conference session server determines condition-related information for determining the user terminal which meets the telecommunication conference session participation condition.

### CROSS-REFERENCE TO RELATED APPLICATION

This application claims priority to German Patent Application Serial No. 10 2007 058 948.6, which was filed Dec. 7, 2007, and is incorporated herein by reference in its entirety.

### TECHNICAL FIELD

Embodiments relate to a method for determining at least one user terminal for a telecommunication conference session, a telecommunication conference arrangement and a telecommunication conference session server.

### BACKGROUND

To use group communication services, it may be desirable for a user to be able to define groups of users so that it is not necessary to individually specify the users with every setting-up of a communication with the user group. For this reason, possibilities for defining user groups in communication systems are desirable for increasing the user-friendliness of group communication services.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a block diagram of a telecommunication conference system according to an illustrative embodiment;

FIG. 2 shows a block diagram of a telecommunication conference system according to an illustrative embodiment in greater detail;

FIG. 3 shows a block diagram of a telecommunication conference system according to an illustrative embodiment in greater detail;

FIG. 4 shows a message flowchart in which the message flow for setting up a conference session according to an illustrative embodiment is shown;

FIG. 5 shows a block diagram of a telecommunication conference system according to another illustrative embodiment in greater detail;

FIG. 6 shows a message flowchart in which the message flow for setting up a conference session according to another illustrative embodiment is shown;

FIG. 7 shows a message flowchart in which the message flow for setting up a conference session according to yet another illustrative embodiment is shown;

FIG. 8 shows a message flowchart in which the message flow for setting up a conference session according to yet another illustrative embodiment is shown; and

FIG. 9 shows a flowchart in which a method according to another illustrative embodiment is shown.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

In the context of the present description, the terms “connected” and “coupled” are used for describing both a direct connection and an indirect connection and a direct or indirect coupling. In the figures, identical or similar elements are provided with identical reference symbols in as much as is appropriate.

In the context of the present description, a circuit is understood to be, for example, any type of hard-wired logic or programmable logic. A circuit can thus be, for example, a programmable processor (for example a programmable microprocessor, for example a complex instruction set controller (CISC) microprocessor or a reduced instruction set controller (RISC) microprocessor) which implements the respective functionality of the circuit (for example by means of a correspondingly arranged program code). Several circuits can be provided integrated in a common circuit or in separate circuits. Thus, it can be provided in one illustrative embodiment that the functionalities, for example of a conference server, are implemented in one or several microprocessors of the conference server.

In a conference system the right to communicate (access right) is usually controlled by means of an access right allocation mechanism. In the context of this mechanism, the user requests an access right from a telecommunication conference server and the server grants the right or does not grant it.

In general, conference systems make it possible to communicate between several users with the aid of communication devices.

To provide for orderly communication, not all users in a conference normally get the right at the same time to communicate via a particular medium (such as, for example, audio, video, text, etc.). Instead, the access rights are normally allocated in accordance with particular predetermined rules. The allocation of access rights is also called floor control and the allocation rules are called floor policy, for example in an Internet-based conference system according to an Internet Conferencing Framework defined by the IETF (Internet Engineering Task Force).

In a large conference room, for example, a conference system is used which provides the users with a number of microphones and loudspeakers for voice communication. The microphones must be switched on for use by the respective speaker. A microphone which is switched on blocks all other microphones so that only one speaker can ever be active. As an exception, one further microphone (for example the microphone of the conference leader) can also be active at the same time. The right to talk is thus always issued to only one user and possibly the conference leader.

A comparable service also exists for mobile radio telephones (push-to-talk services (PTT), for example the “Direct Connect” service by Nextel in the USA or Push-to-Talk over Cellular (PoC) of the Open Mobile Alliance (OMA)). Similar to a walkie-talkie, the speaker usually presses a special key on the mobile radio telephone in order to convey messages. The transmission of messages of other users is blocked during this time. In a conference system according to a proposal of the IETF, access rights are controlled by means of the so-called Binary Floor Control Protocol (BFCP).

In a conventional Push-to-Talk conference system, access rights are requested and allocated by means of the so-called Real Time Transport Control Protocol (RTCP). As an alternative, access rights can also be controlled by means of BFCP.

In a conference system according to a proposal by the IETF (Internet Engineering Task Force), an example of an Internet-based conference system, and in a current push-to-talk conference system (also called PTT conference system in the text which follows), telecommunication sessions are controlled, for example, by using the Session Initiation Protocol (SIP).

Conference systems according to the IETF and PTT conference systems usually have a centralized architecture. This means that the users of such conference systems do not communicate directly with one another but via a central telecommunication server (also called telecommunication conference session server in the text which follows). In a mobile conference system, the central telecommunication server is arranged in the non-mobile part of the telecommunication network as will still be explained in greater detail in the text which follows.

A communication session in a conference system is usually started by a communication session user inviting the other communication session users to the communication session.

A communication session user can also be invited conditionally. In this case at least one condition for users to be invited is linked with the communication session invitation. The condition or the conditions can be sent to the central telecommunication server with the invitation to the conference session. The telecommunication server checks the condition(s) and only invites those communication users to the conference session who meet the condition(s).

The users of a communication session can be invited by an inviting user in that the inviting user sends the addresses of all other users to the central telecommunication server in the invitation. As an alternative, the other users can be invited in that the inviting user sends the address of a communication group (also called user group in the text which follows) to the telecommunication server with the invitation. The telecommunication server enquires, for example from its responsible so-called group management server, which users belong to the communication group.

Communication groups can be hierarchically structured. This means that an invitation can contain group addresses and that groups, in turn, can contain addresses of other groups (also called user group addresses in the text which follows).

The addresses of members of communication groups defined in one's own telecommunication network can be requested by the communication conference server, for example from the group management server of its own telecommunication network. The addresses of members of groups defined in an external telecommunication network can be requested by the communication conference server from the communication conference server of the external telecommunication network in that it sends an invitation with the group address and with an information element which has the first communication conference server as central (controlling) communication conference server, to the external communication conference server. The external communication conference server recognizes from the information element that the group is not to be invited but that the addresses of the group members are requested.

According to the OMA standard, different group management servers are used in different telecommunication networks. In the group management server of a telecommunication network, the communication groups are stored which are defined by communication users of the respective telecommunication network. A communication server of a particular telecommunication network only ever has access to the group management server of this telecommunication network.

This leads to communication session user invitations frequently not being able to take into consideration conditions because the central communication server does not know the members of subgroups of the hierarchical group. This is the case, for example, if subgroups belong to external telecommunication networks or are administered by one or more group management servers of external networks.

Furthermore, presence information of external telecommunication networks can frequently not be used since the external telecommunication network frequently does not allow access to the presence information.

According to various illustrative embodiments, a determination of at least one user terminal is achieved for a telecommunication conference session, wherein optionally at least one telecommunication session user terminal is identified by means of a user terminal group. In various illustrative embodiments, a predefined telecommunication conference session participation condition is allocated to the at least one telecommunication conference session user terminal.

In a method for determining at least one user terminal for a telecommunication conference session (also called conference session in the text which follows) with a multiplicity of telecommunication conference session user terminals, wherein a predefined telecommunication conference session participation condition is allocated to the at least one telecommunication conference session user terminal, an enquiry for determining at least one telecommunication conference session user terminal which meets the telecommunication conference session participation condition is conveyed from a first telecommunication conference session server to a second telecommunication conference session server (the telecommunication conference session servers will also be called conference servers in the text which follows). Condition-related information is determined by means of the second telecommunication conference session server. The predefined telecommunication conference session participation condition is checked by using the determined condition-related information about the at least one telecommunication conference session user terminal and the at least one telecommunication conference session user terminal is determined as user terminal for the telecommunication conference session if the predefined telecommunication conference session participation condition for the telecommunication conference session user terminal is met.

In a method according to another illustrative embodiment for determining at least one user terminal for a telecommunication conference session with a multiplicity of telecommunication conference session user terminals, wherein a predefined telecommunication conference session participation condition is allocated to the at least one telecommunication conference session user terminal, the predefined telecommunication conference session participation condition is checked by involving two telecommunication conference session servers. A first telecommunication conference session server receives an enquiry for determining at least one user terminal for a telecommunication conference session and a second telecommunication conference session server determines at least one communication session user terminal which meets the predefined telecommunication conference session participation condition.

The at least one telecommunication conference session user terminal can be allocated to a user terminal group. Furthermore, the user terminal group can be identified by means of a telecommunication conference session user group identification.

According to a further development, the telecommunication conference session is set up with the determined at least one telecommunication conference session user terminal.

In one embodiment, the telecommunication conference session can be a half-duplex telecommunication conference session, for example a push-to-talk telecommunication conference session, for example a Push-to-Talk over Cellular telecommunication conference session.

In another embodiment, the telecommunication conference session can be an Internet-based telecommunication conference session, for example an Internet-based half-duplex telecommunication conference session.

A half-duplex telecommunication conference is generally understood to be any telecommunication conference in which an access right is in each case assigned to one user of the telecommunication conference, at the most, i.e. a maximum of one user of the telecommunication conference can send messages into the telecommunication conference, all other users of the telecommunication conference act in this case as receivers and thus do not have an access right themselves and cannot send any messages, for example any voice messages, into the telecommunication conference and thus to other users of the telecommunication conference.

An access right is generally understood to be the right of conveying any types of communication data as users of a telecommunication conference to other users of the telecommunication conference. In a telecommunication conference, the data can be multimedia data, for example audio data, video data, static picture data, text data, etc. If audio data are transmitted as part of the telecommunication conference, the access right is also called right to talk for the respective user in the text which follows.

In one illustrative embodiment, the communication session is set up by using at least one telecommunication conference control message according to a telecommunication conference control protocol, wherein the telecommunication conference control protocol can be a protocol of the following protocols (but is not restricted to these examples): Session Initiation Protocol (SIP), Real Time Transport Control Protocol (RTCP), Binary Floor Control Protocol (BFCP).

As will still be explained in greater detail in the text which follows, the communication session, in one illustrative embodiment, can be set up by using at least one Session Initiation Protocol INVITE message and/or at least one Session Initiation Protocol SUBSCRIBE/NOTIFY message as telecommunication conference control message.

The first telecommunication conference session server and the second telecommunication conference session server can be arranged in different telecommunication networks.

Furthermore, the telecommunication conference session user group identification can identify a multiplicity of telecommunication conference session user terminals grouped to form the user group. The telecommunication conference session user group identification can have or be a user group address.

The group identified by means of the telecommunication conference session user group identification can have an additional telecommunication conference session user group identification which identifies at least one additional telecommunication conference session user terminal. In this embodiment, the telecommunication conference session user group identification can have or be a hierarchical user group address since the user group address can have group members who in turn represent a user group and are identified by means of a user group address.

In one embodiment, an enquiry for availability information of the at least one telecommunication conference session user terminal, which is identified by means of the telecommunication conference session user group identification, is sent to a presence server which is arranged in a different telecommunication network from the first telecommunication conference session server.

The telecommunication conference session user group identification can be a telecommunication conference session user group address, for example an SIP address which, for example, identifies the user group.

The telecommunication conference session user group address can have the same structural configuration as a telecommunication conference session user terminal address identifying a single telecommunication conference session user terminal (it can be, for example, an SIP address).

The condition-related information can have different information items, for example at least one personal information item about a user of a user terminal, in other words, for example, personal information about a member of the respective communication group, contained in a communication group list.

In one illustrative embodiment, the condition-related information item has, for example, at least one of the following information items:

an information item about interests of a user of a user terminal,

an information item about the gender of a user of a user terminal,

an information item about the age of a user of a user terminal,

an information item about a profession of a user of a user terminal,

an information item about a spatial location area of at least one telecommunication conference session user terminal.

The condition-related information item can be conveyed to the first telecommunication conference session server.

In one embodiment, the condition-related information item has at least one user terminal address, for example the user terminal address(es) of the user terminals for which the telecommunication conference session participation condition is met.

Furthermore, the first telecommunication conference session server can check the predefined telecommunication conference session participation condition.

In another embodiment, it is provided that the condition-related information item is conveyed by the second telecommunication conference session server to a test circuit and that the test circuit checks the predefined telecommunication conference session participation condition.

In another embodiment, it is provided that the first telecommunication conference session server invites the at least one user terminal to the telecommunication conference session, for example by conveying a telecommunication conference session invitation message (for example an SIP INVITE message) to the at least one user terminal.

In another embodiment, it can be provided that the condition-related information item is conveyed to a telecommunication conference session user terminal inviting to the telecommunication conference session.

In one illustrative embodiment, a user terminal address of the at least one determined telecommunication conference session user terminal is conveyed as the condition-related information to the telecommunication conference session user terminal inviting to the telecommunication conference session.

In another development, a telecommunication conference session user terminal inviting to the telecommunication conference session can invite the at least one user terminal to the telecommunication conference session by conveying a telecommunication conference session invitation message to the at least one user terminal.

Furthermore, it can be provided that the second telecommunication conference session server invites the at least one user terminal to the telecommunication conference session, for example by means of an SIP INVITE message.

In another development, the second telecommunication conference session server can invite the at least one user terminal to the telecommunication conference session by conveying a telecommunication conference session invitation message to the at least one user terminal.

According to another illustrative embodiment, a telecommunication conference arrangement for determining at least one user terminal for a telecommunication conference session with a multiplicity of telecommunication conference session user terminals is provided, wherein a predefined telecommunication conference session participation condition is allocated to the at least one telecommunication conference session user terminal. The telecommunication conference arrangement may have a first telecommunication conference session server which, in turn, may have an enquiry generating circuit configured to generate an enquiry for determining at least one telecommunication conference session user terminal which meets the telecommunication conference session participation condition, and a transmitter configured to transmit the enquiry to a second telecommunication conference session server. Furthermore, the telecommunication conference arrangement may have a second telecommunication conference session server which, in turn, may have a receiver configured to receive the enquiry from the first telecommunication conference session server, and a determination circuit configured to determine the condition-related information item. Furthermore, in the telecommunication conference arrangement, a test circuit is provided which is configured to check a predefined telecommunication conference session participation condition by using the determined condition-related information item about the at least one telecommunication conference session user terminal. A user terminal determination circuit also provided in the telecommunication conference arrangement is configured to determine the at least one telecommunication conference session user terminal as user terminal for the telecommunication conference session when the predefined telecommunication conference session participation condition is met for the telecommunication conference session user terminal.

The at least one telecommunication conference session user terminal can be allocated to a user terminal group. Furthermore, the user terminal group can be identified by means of a telecommunication conference session user group identification.

In one embodiment, the telecommunication conference arrangement, for example the first telecommunication conference session server, has a telecommunication conference session set-up circuit configured to set up the telecommunication conference session with the determined at least one telecommunication conference session user terminal.

The first telecommunication conference session server and the second telecommunication conference session server can be configured to communicate in accordance with a half-duplex telecommunication conference session, for example configured to communicate according to a push-to-talk telecommunication conference session, for example configured to communicate according to a Push-to-Talk over Cellular telecommunication conference session.

In another embodiment, the first telecommunication conference session server and the second telecommunication conference session server can be configured to communicate according to an Internet-based telecommunication conference session, for example configured to communicate according to an Internet-based IETF telecommunication conference session, for example configured to communicate according to a telecommunication conference session according to the IETF Conferencing Framework.

The first telecommunication conference session server and the second telecommunication conference session server can be configured to set up the communication session by using at least one telecommunication conference control message according to a telecommunication conference control protocol, wherein the telecommunication conference control protocol can be a protocol of the following protocols (but is not restricted to these examples): Session Initiation Protocol (SIP), Real Time Transport Control Protocol (RTCP), Binary Floor Control Protocol (BFCP).

Furthermore, the first telecommunication conference session server and the second telecommunication conference session server can be configured to set up the communication session by using at least one Session Initiation Protocol INVITE message and/or at least one Session Initiation Protocol SUBSCRIBE/NOTIFY message as telecommunication conference control message.

In one embodiment, the first telecommunication conference session server and the second telecommunication conference session server may be arranged in different telecommunication networks.

The telecommunication conference session user group identification may identify a multiplicity of telecommunication conference session user terminals grouped to form the user group.

Furthermore, it may be provided that the group identified by means of the telecommunication conference session user group identification has an additional telecommunication conference session user group identification which identifies at least one additional telecommunication conference session user terminal.

The first telecommunication conference session server may also have an enquiry-message-generating circuit configured to generate an enquiry message, wherein the enquiry message may include an enquiry for availability information of the at least one telecommunication conference session user terminal which is identified by means of the telecommunication conference session user group identification. The transmitter of the first telecommunication conference session server may be configured to transmit the enquiry message to a presence server which is arranged in the same telecommunication network as the first telecommunication conference session server.

In various illustrative embodiments, the presence server is configured to determine and provide availability information for one or more user terminals. In the context of the present description, availability information may be understood to be, for example, an information item about whether a user terminal is currently available, for example for a conference session or generally for setting up a communication link. For example, the availability information can contain the so-called online status and/or the position of the respective user terminal. In various illustrative embodiments, the availability information may also contain, for example, information additionally provided by the presence server such as, for example, information such as “mood,” (the mood of the user), “notes” (additional notes or comments with respect to the user terminal), etc. Furthermore, the following information can be contained in the availability information, for example: interests of the user, the gender of the user, the age of the user. In an alternative illustrative embodiment, this personal information about a user can be provided by another entity than the presence server, wherein, in such an example, the other entity can provide the information, for example, to the test circuit (by means of direct or indirect data transmission).

In another embodiment of the telecommunication conference arrangement, a presence server is provided which may be arranged in a different telecommunication network than the first telecommunication conference session server.

The telecommunication conference session user group identification may be a telecommunication conference session user group address.

In one embodiment, the telecommunication conference session user group address has the same structural configuration as a telecommunication conference session user terminal address identifying a single telecommunication conference session user terminal.

The condition-related information item can have at least one personal information item about a user (participant) of a user terminal.

The condition-related information item may have at least one of the following information items:

an information item about interests of a user of a user terminal,

an information item about the gender of a user of a user terminal,

an information item about the age of a user of a user terminal,

an information item about a profession of a user of a user terminal,

an information item about a spatial location area of at least one telecommunication conference session user terminal.

In one embodiment, the condition-related information item has at least one user terminal address, for example the user terminal address(es) of the user terminals for which the telecommunication conference session participation condition is met.

The first telecommunication conference session server can also have a receiver configured to receive the condition-related information.

Furthermore, a test circuit may be provided which is configured to check the predefined telecommunication conference session participation condition.

The first telecommunication conference session server may have the test circuit. In other words, the test circuit may be integrated in the first telecommunication conference session server.

The first telecommunication conference session server may be configured in such a manner that it invites the at least one user terminal to the telecommunication conference session.

Furthermore, the first telecommunication conference session server may be configured in such a manner that it invites the at least one user terminal to the telecommunication conference session by conveying a telecommunication conference session invitation message to the at least one user terminal.

According to one embodiment, the telecommunication conference arrangement may include a telecommunication conference session user terminal inviting to the telecommunication conference session.

The telecommunication conference session user terminal inviting to the telecommunication conference session may be configured to receive the condition-related information.

Furthermore, the telecommunication conference session user terminal inviting to the telecommunication conference session may be configured to receive the condition-related information, wherein the condition-related information may include a user terminal address of the at least one determined telecommunication conference session user terminal.

According to another embodiment, the second telecommunication conference session server may be configured in such a manner that it invites the at least one user terminal to the telecommunication conference session.

For example, the second telecommunication conference session server may be configured in such a manner that it invites the at least one user terminal to the telecommunication conference session by conveying a telecommunication conference session invitation message to the at least one user terminal.

In yet another illustrative embodiment, a telecommunication conference session server may be provided for determining at least one user terminal for a telecommunication conference session with a multiplicity of telecommunication conference session user terminals, wherein a predefined telecommunication conference session participation condition is allocated to the at least one telecommunication conference session user terminal. The telecommunication conference session server may include an enquiry generating circuit configured to generate an enquiry for determining at least one telecommunication conference session user terminal which meets the telecommunication conference session participation condition, and a transmitter configured to transmit the enquiry to another telecommunication conference session server.

The at least one telecommunication conference session user terminal may be allocated to a user terminal group. Furthermore, the user terminal group may be identified by means of a telecommunication conference session user group identification.

In one embodiment, the telecommunication conference session server may have a telecommunication conference session set-up circuit configured to set up the telecommunication conference session with the determined at least one telecommunication conference session user terminal.

The telecommunication conference session server may be configured to communicate in accordance with a half-duplex telecommunication conference session, for example configured to communicate according to a push-to-talk telecommunication conference session, for example configured to communicate according to a Push-to-Talk over Cellular telecommunication conference session.

Furthermore, the telecommunication conference session server may be configured to communicate according to an Internet-based telecommunication conference session, for example an Internet-based half-duplex telecommunication conference session, for example an Internet-based IETF telecommunication conference session.

Furthermore, the telecommunication conference session server may be configured to set up the communication session by using at least one telecommunication conference control message according to a telecommunication conference control protocol, wherein the telecommunication conference control protocol may be a protocol of the following protocols (but is not restricted to these examples): Session Initiation Protocol (SIP), Real Time Transport Control Protocol (RTCP), Binary Floor Control Protocol (BFCP).

In another illustrative embodiment, the telecommunication conference session server may be configured to set up the communication session by using at least one Session Initiation Protocol INVITE message and/or at least one Session Initiation Protocol SUBSCRIBE/NOTIFY message as telecommunication conference control message.

The telecommunication conference session user group identification may identify a multiplicity of telecommunication conference session user terminals grouped to form the user group.

Furthermore, the group identified by means of the telecommunication conference session user group identification may have an additional telecommunication conference session user group identification which identifies at least one additional telecommunication conference session user terminal.

According to one embodiment, the telecommunication conference session server may include an enquiry-message-generating circuit configured to generate an enquiry message, wherein the enquiry message may include an enquiry for availability information of the at least one telecommunication conference session user terminal which is identified by means of the telecommunication conference session user group identification. The transmitter may be configured to transmit the enquiry message to a presence server which may be arranged in the same telecommunication network as the first telecommunication conference session server.

The telecommunication conference session user group identification may have or be a telecommunication conference session user group address.

The telecommunication conference session user group address may have the same structural configuration as a telecommunication conference session user terminal address identifying a single telecommunication conference session user terminal.

The condition-related information item may have at least one personal information item about a user (participant) of a user terminal.

The condition-related information may have at least one of the following information items:

an information item about interests of a user of a user terminal,

an information item about the gender of a user of a user terminal,

an information item about the age of a user of a user terminal,

an information item about a profession of a user of a user terminal,

an information item about a spatial location area of at least one telecommunication conference session user terminal.

In one embodiment, the condition-related information may have at least one user terminal address, for example the user terminal address(es) of the user terminals for which the telecommunication conference session participation condition is met.

According to one illustrative embodiment, the telecommunication conference session server may have a receiver configured to receive the condition-related information.

Furthermore, the telecommunication conference session server may include a test circuit which may be configured to check the predefined telecommunication conference session participation condition.

Furthermore, a user terminal determination circuit may be provided which is configured to determine the at least one telecommunication conference session user terminal as user terminal for the telecommunication conference session when the predefined telecommunication conference session participation condition is met for the telecommunication conference session user terminal.

The telecommunication conference session server may be configured in such a manner that it invites the at least one user terminal to the telecommunication conference session.

Furthermore, the telecommunication conference session server may be configured in such a manner that it invites the at least one user terminal to the telecommunication conference session by conveying a telecommunication conference session invitation message to the at least one user terminal.

In another illustrative embodiment, a method for generating an enquiry for determining at least one user terminal for a telecommunication conference session with a multiplicity of telecommunication conference session user terminals is provided, wherein a predefined telecommunication conference session participation condition is allocated to the at least one telecommunication conference session user terminal. According to the method in this illustrative embodiment, an enquiry for determining at least one telecommunication conference session user terminal which meets the telecommunication conference session participation condition is generated by a telecommunication conference session server.

In yet another illustrative embodiment, a telecommunication conference session server is provided for determining at least one user terminal for a telecommunication conference session with a multiplicity of telecommunication conference session user terminals, wherein a predefined telecommunication conference session participation condition is allocated to the at least one telecommunication conference session user terminal. In this illustrative embodiment, the telecommunication conference session server may include a receiver configured to receive from another telecommunication conference session server an enquiry for determining at least one telecommunication conference session user terminal which meets the telecommunication conference session participation condition, and a determination circuit configured to determine the condition-related information item.

The telecommunication conference session server may be configured to communicate according to a half-duplex telecommunication conference session, for example configured to communicate according to a push-to-talk telecommunication conference session, for example configured to communicate according to a Push-to-Talk over Cellular telecommunication conference session.

Furthermore, the telecommunication conference session server may be configured to communicate according to an Internet-based telecommunication conference session, for example an Internet-based half-duplex telecommunication conference session, for example an Internet-based IETF telecommunication conference session.

Furthermore, the telecommunication conference session server may be configured to set up the communication session by using at least one telecommunication conference control message according to a telecommunication conference control protocol, wherein the telecommunication conference control protocol may be a protocol of the following protocols (but is not restricted to these examples): Session initiation Protocol (SIP), Real Time Transport Control Protocol (RTCP), Binary Floor Control Protocol (BFCP).

In another illustrative embodiment, the telecommunication conference session server may be configured to set up the communication session by using at least one Session Initiation Protocol INVITE message and/or at least one Session Initiation Protocol SUBSCRIBE/NOTIFY message as telecommunication conference control message.

The telecommunication conference session user group identification may identify a multiplicity of telecommunication conference session user terminals grouped to form the user group.

Furthermore, the group identified by means of the telecommunication conference session user group identification may have an additional telecommunication conference session user group identification which identifies at least one additional telecommunication conference session user terminal.

In one illustrative embodiment, the telecommunication conference session user group identification may be a telecommunication conference session user group address.

The telecommunication conference session user group address may have the same structural configuration as a telecommunication conference session user terminal address identifying a single telecommunication conference session user terminal.

The condition-related information item may have at least one personal information item about a user (participant) of a user terminal.

The condition-related information item may have at least one of the following information items:

an information item about interests of a user of a user terminal,

an information item about the gender of a user of a user terminal,

an information item about the age of a user of a user terminal,

an information item about a profession of a user of a user terminal,

an information item about a spatial location area of at least one telecommunication conference session user terminal.

In one embodiment, the condition-related information item has at least one user terminal address, for example the user terminal address(es) of the user terminals for which the telecommunication conference session participation condition is met.

Furthermore, the telecommunication conference session server may include a transmitter configured to transmit the condition-related information item to a test circuit which may be configured to check the predefined telecommunication conference session participation condition.

The telecommunication conference session server may be configured in such a manner that it invites the at least one user terminal to the telecommunication conference session.

Furthermore, the telecommunication conference session server may be configured in such a manner that it invites the at least one user terminal to the telecommunication conference session by conveying a telecommunication conference session invitation message to the at least one user terminal.

In another illustrative embodiment, a method is provided for determining a condition-related information item for determining at least one user terminal for a telecommunication conference session with a multiplicity of telecommunication conference session user terminals, wherein a predefined telecommunication conference session participation condition is allocated to the at least one telecommunication conference session user terminal. According to this method, an enquiry for determining at least one telecommunication conference session user terminal which meets the telecommunication conference session participation condition may be received by another telecommunication conference session server and the condition-related information item may be determined by a telecommunication conference session server receiving the enquiry.

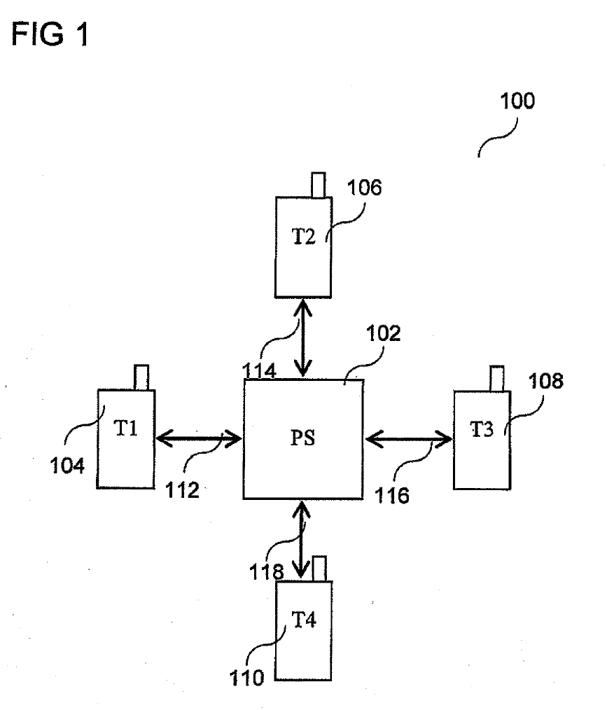

FIG. 1 shows a simplified representation of a telecommunication conference system 100 according to an illustrative embodiment.

The telecommunication conference system 100 is configured in accordance with Push-to-Talk over Cellular (PoC) according to the standard of the Open Mobile Alliance (OMA), the individual components additionally being arranged in such a manner that they can carry out the methods and communication protocols described in the text which follows.

In this context, it should be noted that the architecture of the telecommunication conference system 100 described in FIG. 1 is identical for all illustrative embodiments described in the text which follows.

The telecommunication conference system 100 may include a central push-to-talk over cellular server PS 102 (PTT server) as conference server, and a multiplicity of mobile radio communication terminals, for example mobile radio telephones 104, 106, 108, 110, the mobile radio communication terminals 104, 106, 108, 110 in each case containing a push-to-talk over cellular client unit which is configured to communicate according to the Push-to-Talk over Cellular communication standard. The mobile radio communication terminals 104, 106, 108, 110 are coupled to the PTT server 102 by means of a respective radio communication link 112, 114, 116, 118 via a respective air interface. The users T1, T2, T3, T4, and thus the users of the mobile radio communication terminals 104, 106, 108, 110, thus do not communicate directly with one another but by means of the central PTT server 102.

According to this illustrative embodiment, four users T1, T2, T3, T4, and thus four mobile radio communication terminals 104, 106, 108, 110, are shown in a simplified manner, although an arbitrary number of users and mobile radio communication terminals can be provided. The users T1, T2, T3, T4 communicate by means of audio, i.e. by means of speech, a respective user in each case being assigned exclusively an access right, a right to talk according to the present illustrative embodiment, by the PTT server 102 in accordance with the half-duplex method.

The allocation of the right to talk, the allocation of the access right generally and thus the access right control, is effected by the PTT server 102 by means of messages according to the Real Time Transport Control Protocol (RTCP) communication protocol. Requested access rights may be stored in a queue which is implemented in a memory of the PTT server 102. With the assignment of an access right, each user is assigned a timeslot in which he can transmit voice data to the other users of the telecommunication conference without the other users being able to interrupt him.

During this time, the other users cannot introduce any data into the telecommunication conference, i.e. they do not obtain an access right.

It must be pointed out that, in alternative illustrative embodiments, the telecommunication conference system 100 is configured according to the IETF Conferencing Framework according to a standard of the Internet Engineering Task Force (IETF).

Furthermore, the mobile radio communication terminals 104, 106, 108, 110 may be configured as cordless communication terminals or also as wire-connected communication terminals. The communication terminals may be integrated in a computer, for example in a personal computer, in a workstation, in a personal digital assistant (PDA), a laptop, a notebook, generally any system provided with a processor and which is suitable for participating in a telecommunication conference.

In one illustrative embodiment, the central conference server in the telecommunication conference system 100 may include a controlling function and generally several participating functions communicating with the controlling function. To each user T1, T2, T3, T4, and thus to each mobile radio communication terminal 104, 106, 108, 110, one participating function is allocated. According to one illustrative embodiment, the controlling function may include functionalities which are allocated to the respective PTT session (generally the respective conference session). A participating function may contain functionalities which are allocated to the user belonging to the participating function. A participating function is illustratively a part of the associated user communication terminal 104, 106, 108, 110, this part being arranged in the non-mobile communication network.

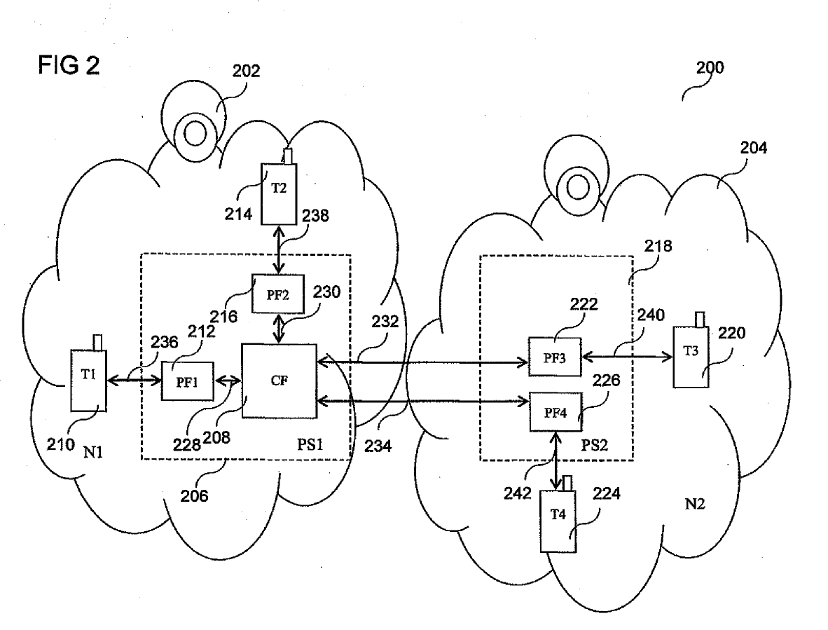

The participating function and the controlling function of users of a PTT conference session may be arranged in different PTT conference servers. This is the case, e.g., if the PTT conference session was generated in the communication network of a communication network operator other than the operator of the user's own communication network. The participating function of the user is then located in a PTT conference server of the user's own communication network operator. The controlling function of the PTT conference session, in contrast, is arranged in a PTT conference server of the other communication network operator. The user, and thus his user communication terminal, communicates with the PTT telecommunication conference session by means of a communication link between the PTT conference server of his own communication network and the PTT conference server of the other communication network. FIG. 2 shows this architecture.

FIG. 2 shows a block diagram of a telecommunication conference system 200 according to an illustrative embodiment in greater detail.

The telecommunication conference system 200 which is also arranged according to a PTT standard, for example according to PoC as described above in conjunction with FIG. 1, has in this example a first communication network N1 202 of a first communication network operator and a second communication network N2 204 of a second communication network operator.

As an alternative, the telecommunication conference system 200 is, for example, an Internet-based conference system (for example arranged according to the IETF Conferencing Framework).

In the example shown in FIG. 2, it is assumed that the first communication network N1 202 has a first conference server 206 which, in turn, for example, has implemented a controlling function (CF) 208 of a telecommunication conference and a participating function (PF) for each communication terminal participating in the telecommunication conference session administered by the controlling function 208, which communication terminal is located in the coverage area of the first communication network N1 202. In this example, it is assumed that a first mobile radio communication terminal (generally a first user terminal) 210 of a first user T1 and a second mobile radio communication terminal (generally a second user terminal) 214 of a second user T2 are located in the first communication network N1 202. The first conference server 206 thus provides a first participating function (PF1) 212 (for the first user terminal 210) and a second participating function (PF2) 216 (for the second user terminal 214).

Furthermore, it is assumed in the example shown in FIG. 2 that the second communication network N2 204 includes a second conference server 218 which, in turn, has implemented a participating function for each communication terminal participating in the telecommunication conference session administered by the controlling function 208 of the first communication network N1 202, which communication terminal is located in the coverage area of the second communication network N2 204. It is assumed in this example that a third mobile radio communication terminal (generally a third user terminal) 220 of a third user T3 and a fourth mobile radio communication terminal (generally a fourth user terminal) 224 of a fourth user T4 are located in the second communication network N2 204. The second conference server 218 thus provides a third participating function (PF3) 222 (for the third user terminal 220) and a fourth participating function (PF4) 226 (for the fourth user terminal 224).

Furthermore, the controlling function 208 of the first communication network N1 202 provides as part of the conference session a respective bidirectional communication link 228, 230, 232, 234 at the controlling function end with a respective participating function 212, 216, 222, 226 and the respective participating function 212, 216, 222, 226 provides a bidirectional communication link 236, 238, 240, 242 at the terminal end with the user terminal 210, 214, 220, 224 allocated to the respective participating function 212, 216, 222, 226.

In one illustrative embodiment, a communication conference session is started in the conference system 100, 200 in that a conference session user invites the other conference session users to the conference session by means of his user terminal.

In a conference session, communication groups may be provided, for example a user group with one or more user terminals and thus with one or more participants in a conference session. A communication group may identify the user terminal or user terminals by means of a user group address (for example an SIP address) in a user group list. The user group list may contain, for example, user terminal addresses of the user terminals of the members of the communication group. In one illustrative embodiment, the user terminal addresses can also be SIP addresses.

In one illustrative embodiment, the communication group or groups can be one or more so-called dynamic communication group(s). In a dynamic communication group, the membership of a user or of his user terminal of the communication group can be established by one or more condition(s) to the user or his user terminal. To illustrate, a dynamic communication group may be understood to be a group of communication participants, wherein the participant or participants is or are established by condition(s) to the user or users, in other words wherein the participation of one or more participants is established by condition(s) to the user or users.

In one illustrative embodiment, a user or his user terminal, respectively, in a communication group may be invited conditionally to a conference session, in other words a user or his user terminal, respectively, is added to a conference session or invited to it, respectively, only if lone or more predefined conditions (also called telecommunication conference session participation condition(s) in the text which follows) is or are met.

In this example, the conference session invitation can be linked, for example, to one or more condition(s) for a user or his user terminal, respectively. The one or more conditions may be sent out with the invitation to the central conference server (for example the first conference server 206). According to one illustrative embodiment, the conference server checks the condition(s) and invites to the conference session users or their user terminals, respectively, which meet the condition(s).

For example, the conference server checks the one or more condition(s) and the at least one conference session user terminal can be determined as user terminal for the conference session if the one or more predefined conference session participation condition(s) is or are met for the user terminal.

The conference server can notify a so-called group management server of all or some of the condition(s) and the group management server checks the condition(s) and reports back to the conference server (for example the first conference server 206) those users or their user terminals, respectively, (for example in the form of their user terminal addresses) which meet the condition(s).

It may also be provided to check the conditions repeatedly automatically (by the communication terminal or by the central conference server) and to invite to the conference session the users or their user terminals, respectively, depending on whether the conditions are met or to cancel the invitation to the conference session again (for example if a respective user or his user terminal had already been invited) or, respectively, to remove this user or his user terminal, respectively, out of the conference session.

Conditions for the membership (or invitation, respectively) of a user or his user terminal in a dynamic communication group may be, e.g.:

interests of the user (if stored in the network (communication network));

gender of the user (if stored in the network (communication network));

age of the user (if stored in the network (communication network));

a predefined particular spatial location area of the user or his user terminal, respectively.

The participants in a communication conference session may be invited by an inviting user in that the inviting user sends the addresses of all other users or their user terminals, respectively, which he wishes to invite to the conference session, in the invitation to the central conference server. As an alternative, the other users may be invited in that the inviting user sends the address of a communication group (also called user group in the text which follows) to the conference server with the invitation. The conference server then enquires, for example with his responsible so-called group management server, which users belong to the communication group specified in each case. As another alternative, users of a communication conference session may be invited by an inviting user in that the inviting user sends to the central conference server one or more conditions in the invitation which must be met by a user or his user terminal, respectively, in order to be invited into the communication conference session; in this case, the users or their user terminals, respectively, are determined which meet the specified one or more conditions.

Instead of sending the condition(s) for the membership of a user to a dynamic communication group with the invitation to the conference server, the condition(s) can also be established in the group management server together with a communication group defined there. In one illustrative embodiment, at least one condition is allocated to at least one member of the communication group in the user group list. The same condition can be allocated to several members of the communication group in the user group list. As an alternative, at least one condition can be allocated unambiguously to each member of the communication group in the user group list. If a communication user invites such a communication group, only members of the communication group who meet the stored condition(s) are invited.

In one illustrative embodiment, the communication groups can be structured hierarchically. This means that an invitation may contain communication group addresses and that communication groups, in turn, can contain addresses of other communication groups. A hierarchical communication group may be understood to be a communication group of communication users whose user list, in turn, contains communication groups.

A hierarchical dynamic communication group may be a hierarchical dynamic communication group over a number of networks (communication networks) whose users belong to several different networks (communication networks).

The communication conference server may request the addresses of members of communication groups defined in its own communication network from the group management server of its own communication network (for example the first communication network N1 202).

The communication conference server (e.g. the first conference server 206) may enquire the addresses of members of communication groups defined in another communication network (for example the second communication network N2 204) from the communication conference server of the other communication network (e.g. the second conference server 218) in that it sends an invitation with the group address and with an information element which identifies the first conference server (e.g. 206) as the central (controlling) conference server, to the other communication conference server (e.g. the second conference server 218). The other conference server (e.g. 218) recognizes from the information element that the communication group is not to be invited but that the addresses of the group members of the communication group are requested by means of the invitation.

According to the OMA standard, different group management servers may be used in different communication networks. In the group management server of a communication network, the communication groups are deposited, in other words stored, which, for example, are defined by a communication user of the respective communication network. In this example, a communication conference server of a particular communication network always has access only to the group management server of this communication network as a result of which the first conference server itself, for example, is not capable of dissolving the communication groups which are defined in the second communication network and determining the user terminal addresses from the user group which are contained in the communication group identified by means of the user group address.

Thus, members of dynamic communication groups frequently cannot be taken into consideration in communication session invitations in a conventional conference communication system because the central conference server does not know the members of other communication networks.

Furthermore, users of other communication networks can often not be taken into consideration since the other communication network does not allow access to information about these users.

Furthermore, it may happen in a conventional conference communication system that no hierarchical dynamic communication groups can be invited since, in a conventional conference communication system, there is no mechanism for inviting the members of dynamic subcommunication groups.

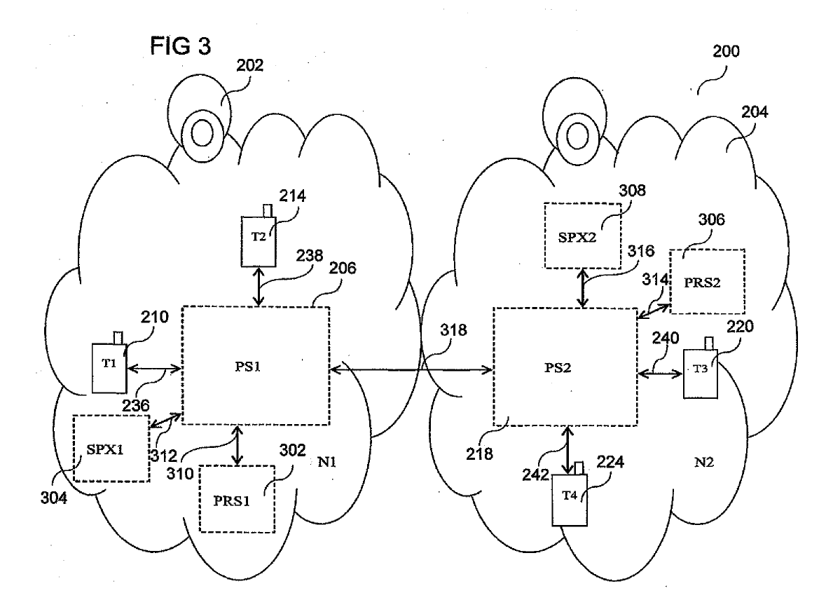

In the text which follows a PoC communication system 200 is considered without restriction of general validity in order to describe illustrative embodiments in even greater detail, referring to FIG. 3. In other words, a communication by PoC service is considered.

In this example, it is assumed that a first group management server (not shown) (which manages the user groups defined in the first communication network N1 202 and which can determine for a user group address the user terminals contained in this group and/or their user terminal addresses), a first presence server PRS1 302, which is configured to determine the presence of a user terminal identified by means of a user terminal address, and a first shared-profile XDMS (XML Document Management Server) SPX1 304 are provided in the first communication network N1 202.

It is also assumed in this example that a second group management server (not shown) (which manages the user groups defined in the second communication network N2 204 and can determine for a user group address the user terminals contained in this group and/or their user terminal addresses), a second presence server PRS2 306, which is configured to determine the presence of a user terminal identified by means of a user terminal address, and a second shared-profile XDMS (XML Document Management Server) SPX2 308 are provided in the second communication network N2 204.

In the illustrative embodiment shown in FIG. 3, the first presence server PRS1 302 is coupled to the first conference server 206 by means of a first bidirectional communication link 310. Furthermore, the first shared-profile XML document management server SPX1 304 is coupled to the first conference server 206 by means of a second bidirectional communication link 312. Furthermore, in the illustrative embodiment shown in FIG. 3, the second presence server PRS2 306 is coupled to the second conference server 218 by means of a third bidirectional communication link 314. Furthermore, the second shared-profile XML document management server SPX2 308 is coupled to the second conference server 218 by means of a fourth bidirectional communication link 316. Furthermore, the first conference server 206 is coupled to the second conference server 218 by means of a fifth bidirectional communication link 318.

In the group management servers are stored (for example in a table or in another suitable form), for example for different communication groups (which are identified, for example, by means of a user group address (for example an SIP address)) in each case an information item about the users contained in the respective communication group (for example, the respective user terminal address of the users of the respective communication group is stored).

In this example, it is assumed that the first user (PoC user) T1 wishes to communicate with users (PoC users) who are interested in football and who are staying in Munich.

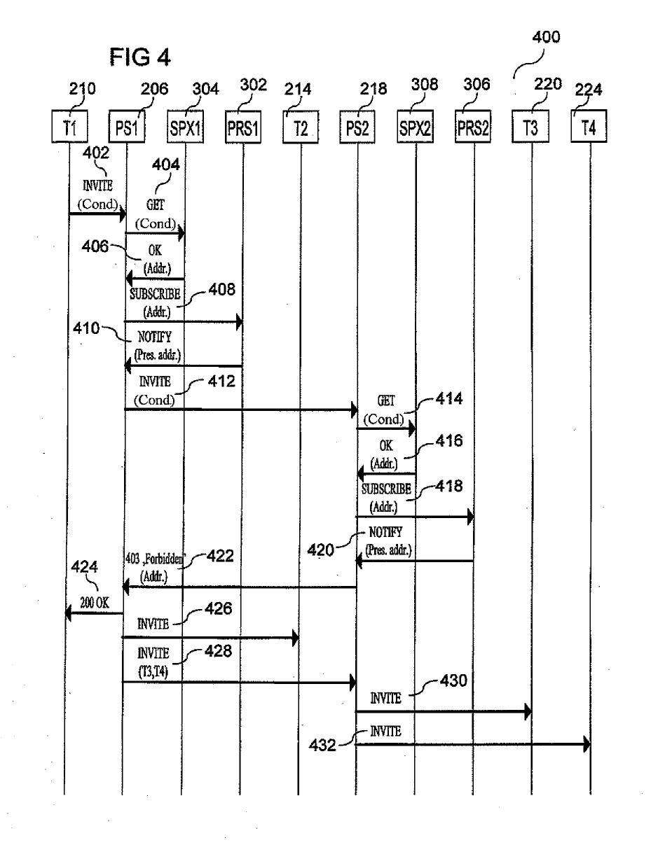

To start the communication conference session, the first user T1 or, respectively, the first user terminal 210 generates and sends out a conference session invitation message which contains at least one predefined telecommunication conference session participation condition, to the first conference server (e.g. first PoC server) PS1 206 of his communication network (e.g. the first communication network N1 202). Optionally, the conference session invitation message may contain addresses of users possibly to be invited who are to be invited if the condition for these users is met (in this case, the conditions are checked not for all possible users but only for the identified users). The conference session invitation message is designated by the reference symbol 402 in a message flowchart 400 in FIG. 4. In this example, the conference session invitation message 402 is an SIP INVITE message as will still be explained in greater detail in the text which follows.

In this example, the conference session invitation message 402 contains (for example in its message body) the conditions “hobbies=football” and “location=Munich” for the users to be invited. In addition, the conference session invitation message 402 contains in this example an information element (e.g. “re-evaluation=FALSE”) which specifies or informs that the condition(s) should be checked only once and not repeatedly. As an alternative, it can be provided, as has been described above, that the condition(s) should be checked repeatedly.

In the following pseudo code representation, the general structure of the SIP INVITE message 402 according to an illustrative embodiment is described:

INVITE sip: PoCConferenceFactoryURI.network1.net SIP/2.0
Max-Forwards: 70
From: sip:T1@network1.net;tag=72648
To: sip: PoCConferenceFactoryURI.network1.net
Contact: <sip:T1.network1.net>
Call-ID: asd88asd77a@1.2.3.4
CSeq: 1 INVITE
Content-Type: text/plain
Content-Length: 58
“hobbies = football”
“location = Munich”
“re-evaluation = FALSE”

To determine in the first communication network N1 202 of the first conference server (e.g. first PoC server) PS1 206 users or user terminals which meet the conditions, the first conference server PS1 206, after receiving the conference session invitation message 402 and after having determined the conditions from the first shared-profile XML document management server SPX1 304 of its communication network (in the present example the first communication network N1 202) requests a list of users (e.g. PoC users) who have specified, and stored in the first shared-profile XML document management server SPX1 304, “football” as their hobby. In an illustrative embodiment this is done by the first conference server PS1 206 generating a first XCAP GET message 404 (which contains the conditions (in the present example the condition “hobbies=football”)) and conveying it to the first shared-profile XML document management server SPX1 304. The first shared-profile XML document management server SPX1 304 may determine those users or their user terminals (for example in the form of their user terminal addresses) who meet the received conditions. The first shared-profile XML document management server SPX1 304 then may generate a user terminal address response message 406 which contains the determined user terminal addresses which meet the conditions (for example in the form of an XCAP OK message 406 which contains the determined user terminal addresses) and conveys it to the first conference server PS1 206.

The first conference server PS1 206 then sends this received list of the determined user terminal addresses to the first presence server PRS1 302 of the first communication network N1 202 and by this means requests location information (as an example of availability information) about the users contained in the received list. In one illustrative embodiment this is done by the first conference server PS1 206, after receiving the user terminal address response message 406, determining the user terminal addresses contained therein and generating a first availability information request message 408, the availability information request message 408 containing at least a part of the (for example all of the) determined user terminal addresses, and convey these to the first presence server PRS1 302. In one illustrative embodiment, the availability information request message 408 is an SIP SUBSCRIBE message 408.

The first presence server PRS1 302 determines the location information for the user terminal addresses contained in the availability information request message 408 received by it. It then generates an availability information response message 410 which contains the determined location information and conveys it to the first conference server PS1 206. In one illustrative embodiment, the availability information response message 410 is an SIP NOTIFY message 410.

It should be pointed out that the determination of the location areas of the users or their user terminals, respectively, can also take place before or at the same time as the determination of the users or their user terminals, respectively, which meet the conditions with regard to the information stored in the first shared-profile XML document management server SPX1 304.

After receiving the availability information response message 410, the first conference server PS1 206 checks the determined location information and determines all users or their user terminals, respectively, which are located in Munich. These users or their user terminals are stored by the first conference server PS1 206 in a memory (not shown).

To determine users in the other communication network (for example the second communication network N2 204) who meet the conditions, the first conference server PS1 206 generates a further conference session invitation message 412 and conveys it to the second conference server PS2 218. The further conference session invitation message 412 contains the conditions in its message body. In one illustrative embodiment, the further conference session invitation message 412 is a further SIP INVITE message 412. In one illustrative embodiment, the further conference session invitation message 412 also contains the feature tag ‘isfocus’. The feature tag informs the receiving second conference server PS2 218 that the second conference server PS2 3218 should not be central conference server and invite users to the conference session but that the addresses of users to be invited to the conference session should be reported back, in the example to the first conference server 206.

In the following pseudo code representation, the general structure of the further SIP INVITE message 412 according to an illustrative embodiment is described:

INVITE sip: PTTServer2.network2.net SIP/2.0
Max-Forwards: 70
From: sip:T1@network1.net;tag=72648
To: sip:PoC.network2.net
Contact: <sip:Session1@PTTServer1.network1.net>; isfocus
Call-ID: asd88asd77a@1.2.3.4
CSeq: 1 INVITE
Content-Type: text/plain
Content-Length: 58
“hobbies = football”
“location = Munich”
“re-evaluation = FALSE”

The addresses to be invited and reported back are determined by the second conference server (e.g. PoC server) PS2 218 in similar or identical manner as by the first conference server 206 in the first communication network N1 202. Thus, the second conference server PS2 218 first requests from the second shared-profile XML document management server SPX2 308 of its communication network (e.g. the second communication network N2 204) the users in the second communication network N2 204 who are interested in football, and then enquires location information for the users interested in football from the second presence server PRS2 306 of its communication network (e.g. the second communication network N2 204).

In detail, this is done, for example, in that the second conference server PS2 218, after receiving the further conference session invitation message 412, generates a second user terminal address request message 414 (e.g. a second XCAP GET message 414) (which contains the conditions (in the present example the condition “hobbies=football”)) and conveys it to the second shared-profile XML document management server SPX2 308. The second shared-profile XML document management server SPX2 308 determines the users or their user terminals, respectively (for example in the form of their user terminal addresses) who meet the received conditions. The second shared-profile XML document management server SPX2 308 then generates a second user terminal address response message 416 which contains the determined user terminal addresses which meet the conditions (for example in the form of a second XCAP OK message 416 which contains the determined user terminal addresses) and conveys it to the second conference server PS2 218.

The second conference server PS2 218 then sends this received list of determined user terminal addresses to the second presence server PRS2 306 of the second communication network N2 204 and by this means requests location information (as an example of availability information) about the users contained in the received list. In one illustrative embodiment, this is done by the second conference server PS2 218, after receiving the second user terminal address response message 416, determining the user terminal addresses contained therein and generating a second availability information request message 418, wherein the second availability information request message 418 contains at least a part of the (for example all of the) determined user terminal addresses, and conveying it to the second presence server PRS2 306. In one illustrative embodiment, the second availability information request message 418 is a second SIP SUBSCRIBE message 418.

It should be pointed out that the determination of the location areas of the users or their user terminals, respectively, can also take place before or at the same time as the determination of the users or their user terminals, respectively, which meet the conditions with regard to the information stored in the second shared-profile XML document management server SPX2 308.

The second presence server PRS2 306 determines the location information for the user terminal addresses contained in the second availability information request message 418 received by it. It then generates a second availability information response message 420 which contains the determined location information, and conveys this to the second conference server PS2 218. In one illustrative embodiment, the second availability information response message 420 is a second SIP NOTIFY message 420.

After receiving the second availability information response message 420, the second conference server PS2 218 checks the determined location information and determines all users or their user terminals, respectively, who are located in Munich. These users or their user terminals, respectively, are temporarily stored by the second conference server PS2 218 in a memory (not shown).

After the second conference server PS2 218 has determined the users or user terminals, respectively, staying in Munich, and has thus determined the members of the dynamic hierarchical communication group from the second communication network N2 204, the second conference server PS2 218 conveys the user terminal addresses of the determined users or user terminals, respectively, which meet the conditions and are administered in the second communication network N2 204, to the first conference server PS1 206. According to one illustrative embodiment, this is done by the second conference server PS2 218 generating a second communication network user message 422 and conveying it to the first conference server PS1 206. The second communication network user message 422 contains the user terminal addresses, determined by the second conference server PS2 218, which meet the predefined conditions. The second communication network user message 422 can be an SIP 403 ‘forbidden’ message 422 with the user terminal addresses of users to be invited reported back.

In the following pseudo code representation, the general structure of the SIP 403 ‘forbidden’ message 422 according to one illustrative embodiment is described:

SIP/2.0 403 Forbidden
From: sip:T1@network1.net;tag=72648
To: sip:PoC.network2.net
Call-ID: asd88asd77a@1.2.3.4
CSeq: 1 INVITE
Content-Type: text/plain
Content-Length: 39
sip:T3@network2.net
sip:T4@network2.net

The user terminal addresses (“sip:T3@network2.net” and “sip:T4@network2.net”) contained in the message body of the SIP 403 “forbidden” message 422 are the addresses of the user terminals which meet the predefined conditions.

After the first conference server PS1 206 has received the second communication network user message 422 and has thus determined the user terminal addresses of all required users of the conference, the first conference server PS1 206 sends invitations (for example in the form of user invitation messages) to the second user terminal 214 of the second user T2 and to the third user terminal 220 of the third user T3 and to the fourth user terminal 224 of the fourth user T4. In addition, the first conference server PS1 206 notifies the first user terminal 210 of the first user T1 that invitations to the conference session have been issued.

The server invitation message 426 conveyed to the second user terminal 214 of the second user T2 is an SIP INVITE message 426 according to one illustrative embodiment. The user terminals located in the second communication network N2 204 may be invited by the first conference server PS1 206 generating a common or two individual SIP INVITE message(s) 428 and conveying it/these to the second conference server PS2 218. Following the reception of the common SIP INVITE message 428, the second conference server PS2 218 generates for each user terminal to be invited (e.g. 220, 224) in the second communication network N2 204 a respective SIP INVITE message 430 and 432 and conveys these to the respective user terminals to be invited (e.g. 220, 224).

In addition, the first conference server PS1 206 notifies the first user terminal 210 of the first user T1 that invitations to the conference session have been issued, by means of a conference set-up confirmation message 424 (for example in the form of an SIP 200 OK message 424) which is generated by the first conference server PS1 206 and conveyed to the first (the inviting) user terminal 210 of the first user T1.

As an alternative, the conference set-up confirmation message 424 may also be sent to the first user terminal 210 of the first user T1 only when the first conference server PS1 206 has received an acceptance of their invitation from at least one invited user terminal 210, 220, 224 (not shown in FIG. 4).

The conference session can now be established between all user terminals which accept the invitation to the conference session.

According to one illustrative embodiment, if the condition(s) was (were) not met at the time of the invitation, the respective communication server PS1 206, PS2 218 optionally checks the condition(s) again later. As soon as the condition(s) is or are met, the first communication server PS1 206 invites the users to a conference session.

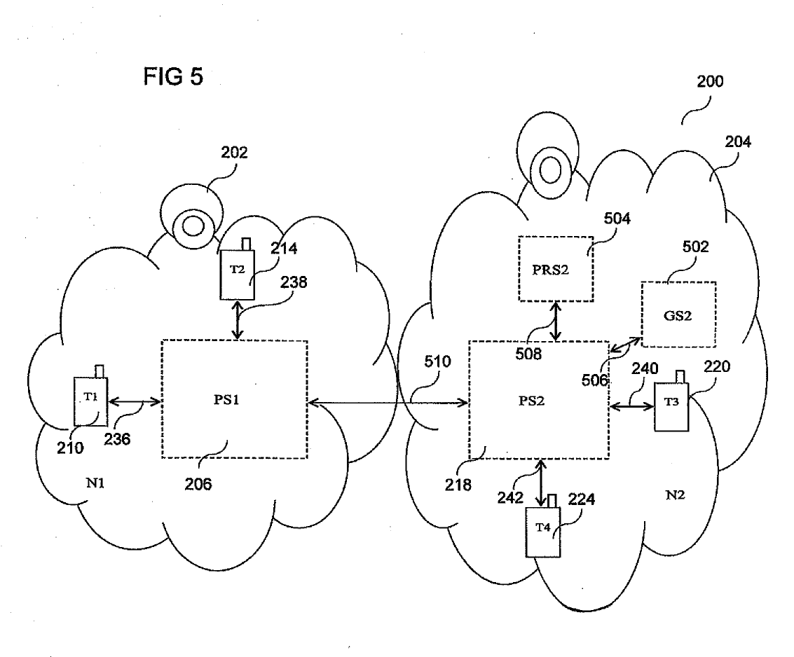

In the text which follows, another illustrative embodiment is described with reference to FIG. 5. In other words, a communication by PoC service is considered.

It is assumed in this example that a group management server GS2 502 (which administers the user groups defined in the second communication network N2 204 and can determine for a user group address the user terminals contained in this group and/or their user terminal addresses) and a presence server PRS2 504, which is arranged for determining the presence of a user terminal identified by means of a user terminal address, are provided in the second communication network N2 204.

In the illustrative embodiment shown in FIG. 5, the group management server 502 is coupled to the second conference server 218 by means of a first bidirectional communication link 506. Furthermore, the presence server 504 is coupled to the second conference server 218 by means of a second bidirectional communication link 508. Furthermore, the first conference server 206 and the second conference server 218 are coupled to one another by means of a third bidirectional communication link 510.

Furthermore, it is assumed in this example that the first user (PoC user) T1 wishes to communicate with the second user (PoC user) T2 and with his friends who happen to be staying in Munich. The second user (PoC user) T2 belongs to the first communication network N1 202 to which the first user (PoC user) T1 also belongs. A communication group G1 of the friends in Munich is defined in the group management server 502 of the second communication network N2 204 since this communication group G1 was generated by a friend in the second communication network N2 204.

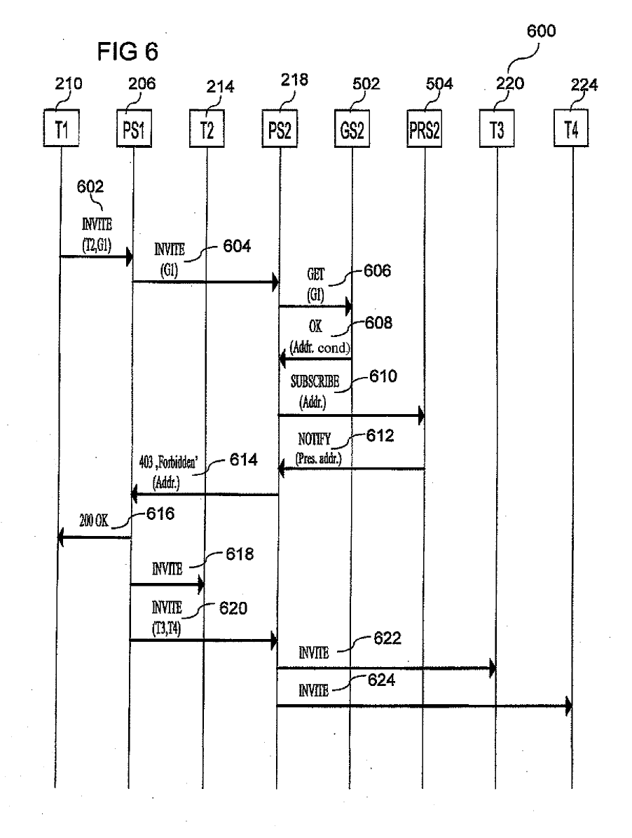

To start the communication conference session, the first user T1 or his first user terminal 210, respectively, generates a conference session invitation message which contains the user terminal address of the second user terminal 214, and the user group address of the communication group G1, and sends the conference session invitation message to the first conference server (e.g. first PoC server) PS1 206 of his communication network (e.g. the first communication network N1 202). The conference session invitation message is designated by a reference symbol 602 in a message flowchart 600 in FIG. 6. In this example, the conference session invitation message 602 is an SIP INVITE message as will still be explained in greater detail in the text which follows.

After receiving the conference session invitation message 602, the first conference server PS1 206 checks the received addresses (for example the user terminal address of the second user T2 and the user group address of the communication group G1), and finds in the present example that the user group address of the communication group G1 is an address which belongs to another communication network (for example the second communication network N2 204). The first conference server PS1 206 therefore requests the user terminal addresses of the members of the communication group G1 from the second conference server PS2 218 of the second communication network 204.

This is done, for example, by the first conference server PS1 206 generating a further conference session invitation message 604 and conveying it to the second conference server PS2 218. In one illustrative embodiment, the further conference session invitation message 604 is an SIP INVITE message 604. The further conference session invitation message 604 contains the user group address of the communication group G1 as addressee. In addition, the further conference session invitation message 604 contains the feature tag ‘isfocus’ in one illustrative embodiment. The feature tag informs the receiving server PS2 that the second conference server PS2 204 should not be the central conference server and invite the members of the communication group G1 but that the user group addresses of the communication group G1 should be reported back to the first conference server PS1 206.

After receiving the further conference session invitation message 604, the second conference server PS2 218 requests the addresses of the group members of the communication group G1 from its appropriate group management server GS2 502. The group management server GS2 502 responds with a list of the user terminal addresses of the friends of the first user T1. In the group management server GS2 502, the condition “location=Munich” is deposited, in other words stored, for the communication group G1 in the present example. The group management server GS2 502 therefore also informs the second conference server PS2 218 of this condition.

In detail, this is done, for example, by the second conference server PS2 218, after receiving the further conference session invitation message 604, generating a user terminal address request message 606 (e.g. an XCAP GET message 606) (which contains the user group address of the communication group G1) and conveying it to the group management server GS2 502. The group management server GS2 502 determines the members of the communication group G1, their user terminal addresses and the condition(s) allocated to these. The group management server GS2 502 then generates a user terminal address response message 608 which contains the determined user terminal addresses and the conditions (for example in the form of an XCAP OK message 608 which contains the determined user terminal addresses), and conveys it to the second conference server PS2 218. The second conference server PS2 218 then sends this received list of determined user terminal addresses to the second presence server PRS2 504 of the second communication network N2 204 and by this means requests location information (as an example of availability information) about the users contained in the received list. In one illustrative embodiment, this is done by the second conference server PS2 218, after receiving the user terminal address response message 608, determining the user terminal addresses contained therein and generating an availability information request message 610, the availability information request message 610 containing at least a part of the (for example all of the) determined user terminal addresses, and conveying these to the second presence server PRS2 504. In one illustrative embodiment, the availability information request message 610 is an SIP SUBSCRIBE message 610.

The second presence server PRS2 504 determines the location information for the user terminal addresses contained in the availability information request message 610 received by it. It then generates an availability information response message 612 which contains the determined location information and conveys this to the second conference server PS2 218. In one illustrative embodiment, the availability information response message 612 is an SIP NOTIFY message 612.

It should be pointed out that, in an alternative illustrative embodiment, the order of determination of the information described above by the group management server GS2 502 and the second presence server PRS2 504 can also be reversed from the present example. The information can also be determined simultaneously.

After receiving the availability information response message 612, the second conference server PS2 218 may check the determined location information and may determine all users or their user terminals, respectively, which are located in Munich. These users or their user terminals, respectively, are temporarily stored by the second conference server PS2 218 in a memory.

Once the second conference server PS2 218 has determined the users or user terminals, respectively, staying in Munich and has thus determined the members of the dynamic hierarchical communication group from the second communication network N2 204, the second conference server PS2 218 may convey the user terminal addresses of the determined users or user terminals, respectively, which meet the conditions and are administered in the second communication network N2 204, to the first conference server PS1 206. According to one illustrative embodiment, this is done by the second conference server PS2 218 generating a second communication network user message 614 and conveying it to the first conference server PS1 3206. The second communication network user message 614 contains the user terminal addresses, determined by the second conference server PS2 218, which meet the predefined conditions. The second communication network user message 614 may be an SIP 403 ‘forbidden’ message 614 with the user terminal addresses of users to be invited reported back.

Once the first conference server PS1 206 has received the second communication network user message 614 and has thus determined the user terminal addresses of all required participants in the conference, the first conference server PS1 206 generates and sends out invitations (for example in the form of user invitation messages) to the second user terminal 214 of the second user T2 and to the third user terminal 220 of the third user T3 and to the fourth user terminal 224 of the fourth user T4. In addition, the first conference server PS1 206 notifies the first user terminal 210 of the first user T1 that invitations to the conference session have been issued.

According to one illustrative embodiment, the user invitation message 618 conveyed to the second user terminal 214 of the second user T2 is an SIP INVITE message 618. The user terminals located in the second communication network N2 204 are invited by the first conference server PS1 206 generating one common or two individual SIP INVITE message(s) 620 and conveying it/these to the second conference server PS2 218. Following the reception of the common SIP INVITE message 620, the second conference server PS2 218 generates for each user terminal to be invited (e.g. 220, 224) in the second communication network N2 204 a respective SIP INVITE message 622 and 624 and conveys these to the respective user terminals to be invited (e.g. 220, 224).

In addition, the first conference server PS1 206 notifies the first user terminal 210 of the first user T1 that invitations to the conference session have been issued, by means of a conference set-up confirmation message 616 (for example in the form of an SIP 200 OK message 616) which is generated by the first conference server PS1 206 and is conveyed to the first (the inviting) user terminal 210 of the first user T1.

As an alternative, the conference set-up confirmation message 616 can also be sent to the first user terminal 210 of the first user T1 only when the first conference server PS1 206 has received an acceptance of their invitation from at least one invited user terminal 210, 220, 224 (not shown in FIG. 6).

The conference session can now be established between all user terminals which accept the invitation to the conference session.

According to one illustrative embodiment, if the condition(s) was (were) not met at the time of the invitation, the respective communication server PS1 206, PS2 218 optionally checks the condition(s) again later. As soon as the condition(s) is or are met, the first communication server PS1 206 may invite the users to a conference session.

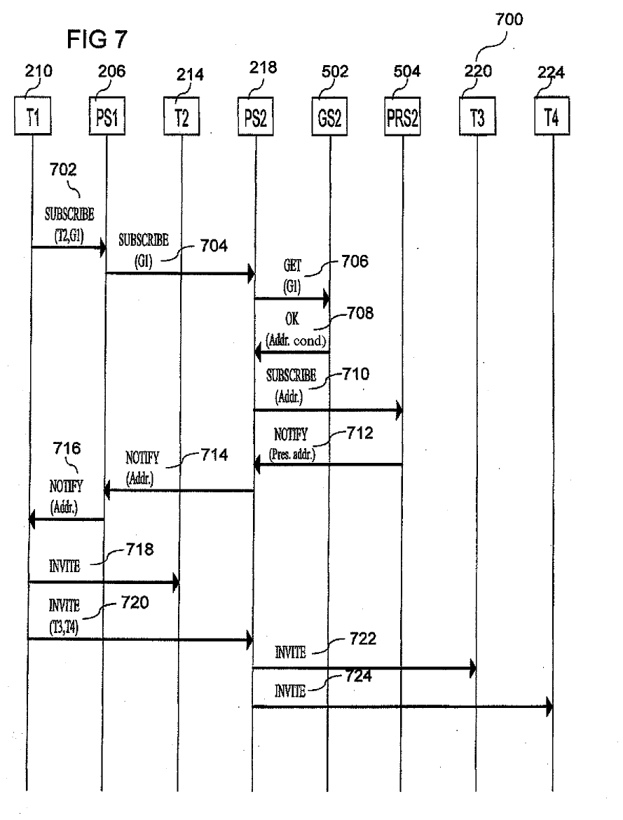

In the text which follows, an example of another solution for the situation of the example described in conjunction with FIG. 5 and FIG. 6 is described referring to FIG. 7. Communication by PoC service is again considered.

In this example, too, it is assumed that the first user (PoC user) T1 wishes to communicate with the second user (PoC user) T2 and with his friends who happen to be staying in Munich. The second user (PoC user) T2 belongs to the first communication network N1 202 to which the first user (PoC user) T1 also belongs. A communication group G1 of the friends in Munich is defined in the group management server 502 of the second communication network N2 204 since this communication group G1 was generated by a friend in the second communication network N2 204.

To start the communication conference session, the first user T1 or his first user terminal 210, respectively, generates an address request message which contains the user terminal address of the second user terminal 214 and the user group address of the communication group G1 to the first conference server (e.g. first PoC server) PS1 206 of his communication network (e.g. the first communication network N1 202). The address request message is designated by the reference symbol 702 in a message flowchart 700 in FIG. 7. In this example, the address request message 702 is an SIP SUBSCRIBE message as will still be explained in greater detail in the text which follows.

After receiving the address request message 702, the first conference server PS1 206 checks the received addresses (for example the user terminal address of the second user T2 and the user group address of the communication group G1) and, in the present example, finds that the user group address of the communication group G1 is an address which belongs to another communication network (for example the second communication network N2 204). The first conference server PS1 206 therefore requests the user terminal addresses of the members of the communication group G1 from the second conference server PS2 218 of the second communication network 204.

This is done, for example, by the first conference server PS1 206 generating a further address request message 704 and conveying it to the second conference server PS2 218. In one illustrative embodiment, the further address request message 704 is an SIP SUBSCRIBE message 704. The further address request message 704 contains the user group address of the communication group G1 as addressee.

After receiving the further address request message 704, the second conference server PS2 218 requests the addresses of the group members of the communication group G1 from its appropriate group management server GS2 502. The group management server GS2 502 responds with a list of the user terminal addresses of the friends of the first user T1. In the present example, the condition “location=Munich” is deposited, in other words stored, in the group management server GS2 502 for the communication group G1. The group management server GS2 502 therefore also informs the second conference server PS2 218 of this condition.

In detail, this is done, for example, by the second conference server PS2 218, after receiving the farther address request message 704, generating a user terminal address request message 706 (e.g. an XCAP GET message 706) (which contains the user group address of the communication group G1) and conveying it to the group management server GS2 502. The group management server GS2 502 determines the members of the communication group G1, their user terminal addresses and the condition(s) allocated to these. The group management server GS2 502 then generates a user terminal address response message 708 which contains the determined user terminal addresses and the conditions (for example in the form of an XCAP OK message 708 which contains the determined user terminal addresses) and conveys it to the second conference server PS2 218. The second conference server PS2 218 then sends this received list of determined user terminal addresses to the second presence server PRS2 504 of the second communication network N2 204 and by this means requests location information (as an example of availability information) about the users contained in the received list. In one illustrative embodiment this is done by the second conference server PS2 218, after receiving the user terminal address response message 708, determining the user terminal addresses contained therein and generating an availability information request message 710, the availability information request message 710 containing at least a part of (for example all of) the determined user terminal addresses, and conveying these to the second presence server PRS2 504. In one illustrative embodiment, the availability information request message 710 is an SIP SUBSCRIBE message 710.

The second presence server PRS2 504 determines the location information for the user terminal addresses contained in the availability information request message 710 received by it. It then generates an availability information response message 712 which contains the determined location information and conveys it to the second conference server PS2 218. In one illustrative embodiment, the availability information response message 712 is an SIP NOTIFY message 712.

It should be pointed out that, in an alternative illustrative embodiment, the order of determination of the information described above, by the group management server GS2 502 and the second presence server PRS2 504, can also be the reverse of the present example. The information may also be determined simultaneously.

After reception of the availability information response message 712, the second conference server PS2 218 may check the determined location information and may determine all users, or their user terminals, respectively, who are staying in Munich. These users or their user terminals, respectively, are temporarily stored by the second conference server PS2 218 in a memory (not shown).

Once the second conference server PS2 218 has determined the users or user terminals, respectively, staying in Munich, and has thus determined the members of the dynamic hierarchical communication group from the second communication network N2 204, the second conference server PS2 218 conveys the user terminal addresses of the determined users or user terminals, respectively, which meet the conditions and are administered in the second communication network N2 204, to the first conference server PS1 206. According to one illustrative embodiment, this is done by the second conference server PS2 218 generating a second communication network user message 714 and conveying it to the first conference server PS1 206. The second communication network user message 714 contains the user terminal addresses, determined by the second conference server PS2 218, which meet the predefined conditions. In this example, the second communication network user message 714 may be an SIP NOTIFY message 714 with the user terminal addresses of users to be invited reported back.

In this example, the first conference server 206, after receiving the second communication network user message 714, may generate a further second communication network user message 716 and convey it to the first user terminal 210. In this example, the further second communication network user message 716 may be an SIP NOTIFY message 716 with the user terminal addresses of users to be invited reported back.

Once the first user terminal 210 has received the further second communication network user message 716 and has thus determined the user terminal addresses of all required participants in the conference, the first user terminal 210 may generate and send out invitations (for example in the form of invitation messages) to the second user terminal 214 of the second user T2 and to the third user terminal 220 of the third user T3 and to the fourth user terminal 224 of the fourth user T4.

According to one illustrative embodiment, the invitation message 718 conveyed to the second user terminal 214 of the second user T2 is an SIP INVITE message 718. The user terminals located in the second communication network N2 204 are invited by the first user terminal 210 generating one common or two individual SIP INVITE message(s) 720 and conveying it/these to the second conference server PS2 218. Following the reception of the common SIP INVITE message 720, the second conference server PS2 218 generates for each user terminal to be invited (e.g. 220, 224) in the second communication network N2 204 a respective SIP INVITE message 722 and 724 and conveys these to the respective user terminals to be invited (e.g. 220, 224).

The conference session can now be established between all user terminals which accept the invitation to the conference session.

According to one illustrative embodiment, if the condition(s) was (were) not met at the time of the invitation, the respective communication server PS1 206, PS2 218 optionally checks the condition(s) again later. As soon as the condition(s) is or are met, the first user terminal 210 invites the users to a conference session.

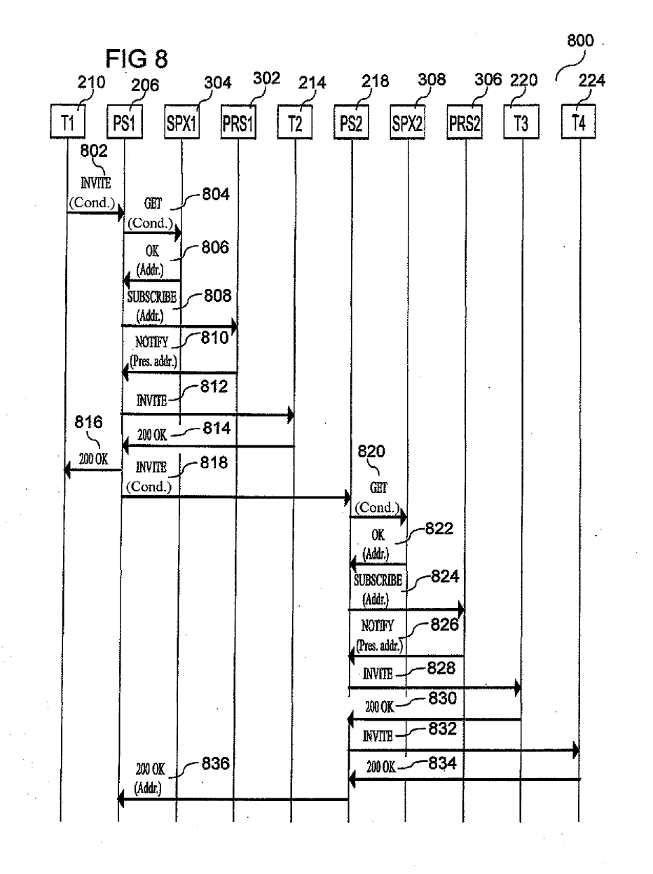

In the text which follows, another illustrative embodiment which can be carried out in the PoC communication system 200 shown in FIG. 3 and described is described with reference to FIG. 8. Again, communication by PoC service is considered.

In this example, it is assumed that the first user (PoC user) T1 wishes to communicate with users (PoC users) who are interested in football and are staying in Munich.

To start the communication conference session, the first user T1 or the first user terminal 210, respectively, generates and sends out a conference session invitation message which contains at least one predefined telecommunication conference session participation condition, to the first conference server (e.g. first PoC server) PS1 206 of its communication network (e.g. the first communication network N1 202). Optionally, the conference session invitation message may contain addresses of users possibly to be invited, who are to be invited if the condition for these users is met (in this case, the conditions are not checked for all possible users but only for the identified users). The conference session invitation message is designated by the reference symbol 802 in a message flowchart 800 in FIG. 8. In this example, the conference session invitation message 802 is an SIP INVITE message as will still be explained in greater detail in the text which follows.

In this example, the conference session invitation message 802 contains (for example in its message body) the conditions “hobbies=football” and “location=Munich” for the users to be invited. In addition, the conference session invitation message 802 contains in this example an information element (e.g. “re-evaluation=FALSE”) which specifies or informs that the condition(s) should only be checked once and not repeatedly. As an alternative, it can be provided, as has been described above, that the condition(s) should be checked repeatedly.

In the following pseudo code representation, the general structure of the SIP INVITE message 802 according to an illustrative embodiment is described:

INVITE sip: PoCConferenceFactoryURI.network1.net SIP/2.0
Max-Forwards: 70
From: sip:T1@network1.net;tag=72648
To: sip: PoCConferenceFactoryURI.network1.net
Contact: <sip:T1.network1.net>
Call-ID: asd88asd77a@1.2.3.4
CSeq: 1 INVITE
Content-Type: text/plain
Content-Length: 58
“hobbies = football”
“location = Munich”
“re-evaluation = FALSE”

To determine in the first communication network N1 202 of the first conference server (e.g. first PoC server) PS1 206 users or user terminals, respectively, which meet the conditions, the first conference server PS1 206, after receiving the conference session invitation message 802 and after having determined the conditions, requests from the first shared-profile XML document management server SPX1 304 of its communication network (in the present example of the first communication network N1 202) a list of users (e.g. PoC users) who have specified, and stored in the first shared-profile XML document management server SPX1 304, “football” as their hobby. In one illustrative embodiment this is done by the first conference server PS1 206 generating a first XCAP GET message 804 (which contains the conditions (in the present example the condition “hobbies=football”)) and conveying it to the first shared-profile XML document management server SPX1 304. The first shared-profile XML document management server SPX1 304 determines those users or their user terminals, respectively (for example in the form of their user terminal addresses) which meet the received conditions. The first shared-profile XML document management server SPX1 304 then generates a user terminal address response message 806 which contains the determined user terminal addresses which meet the conditions (for example in the form of an XCAP OK message 806 which contains the determined user terminal addresses) and conveys it to the first conference server PS1 206.

The first conference server PS1 206 then sends this received list of determined user terminal addresses to the first presence server PRS1 302 of the first communication network N1 202 and by this means requests location information (as an example of availability information) about the users contained in the received list. In one illustrative embodiment this is done by the first conference server PS1 206, after receiving the user terminal address response message 806, determining the user terminal addresses contained therein and generating a first availability information request message 808, the availability information request message 808 containing at least a part of the (for example all of the) determined user terminal addresses, and conveying these to the first presence server PRS1 302. In one illustrative embodiment, the availability information request message 808 is an SIP SUBSCRIBE message 808.

The first presence server PRS1 302 determines the location information for the user terminal addresses contained in the availability information request message 808 received by it. It then generates an availability information response message 810 which contains the determined location information and conveys this to the first conference server PS1 206. In one illustrative embodiment, the availability information response message 810 is an SIP NOTIFY message 810.

It should be pointed out that the determination of the location areas of the users or their user terminals, respectively, can also take place before or at the same time as the determination of the users or their user terminals, respectively, which meet the conditions with regard to the information stored in the first shared-profile XML document management server SPX1 304.

After receiving the availability information response message 810, the first conference server PS1 206 checks the determined location information and determines all users or their user terminals, respectively, which are staying in Munich. These users or their user terminals, respectively, are stored by the first conference server PS1 206 in a memory (not shown).

In the present example, it is assumed that the second user T2 or his second user terminal 214, respectively, is located in Munich and is interested in football.

According to the present illustrative embodiment, the first conference server PS1 206 then invites the second user T2 or his second user terminal 214, respectively (generally the users or user terminals, respectively, determined in the phase described above) by means of a conference session invitation message 812 which is generated by the first conference server PS1 206 and conveyed to the users or user terminals hitherto determined (in the present example the second user T2 or his second user terminal 214, respectively). In one illustrative embodiment, the conference session invitation message 812 is an SIP INVITE message 812.

It is also assumed in the present example that the second user T2 or his second user terminal 214, respectively, wishes to participate in the conference to which he has been invited. The second user terminal 214 thus generates a first invitation acceptance message 814 and conveys it to the first conference server PS1 206. In one illustrative embodiment, the first invitation acceptance message 814 is an SIP 200 OK message 814.

As soon as an invited user has accepted the invitation, the first conference server PS1 206 notifies the inviting first user (PoC user) T1 or his first user terminal 210, respectively, that his invitation was successful. According to one illustrative embodiment this is done by the first conference server PS1 206, after receiving the first invitation acceptance message 814, generating a conference set-up confirmation message 816 (for example in the form of an SIP 200 OK message 816) and conveying it to the first (the inviting) user terminal 210 of the first user T1.

To invite users in the other communication network (for example the second communication network N2 204), who meet the conditions, the first conference server PS1 206 generates a further conference session invitation message 818 and conveys it to the second conference server PS2 218. The further conference session invitation message 818 contains the conditions in its message body. In one illustrative embodiment, the further conference session invitation message 818 is a further SIP INVITE message 818. In one illustrative embodiment, the further conference session invitation message 818 also contains the feature tag ‘isfocus’. The feature tag informs the receiving second conference server PS2 218 that the second conference server PS2 218 should not be the central conference server and that it should invite to the conference session users who meet the conditions.

In the following pseudo code representation, the general structure of the further SIP INVITE message 812 according to one illustrative embodiment is described:

INVITE sip: PTTServer2.network2.net SIP/2.0
Max-Forwards: 70
From: sip:T1@network1.net;tag=72648
To: sip:PoC.network2.net
Contact: <sip:Session1@PTTServer1.network1.net>;isfocus
Call-ID: asd88asd77a@1.2.3.4
CSeq: 1 INVITE
Content-Type: text/plain
Content-Length: 58
“hobbies = football”
“location = Munich”
“re-evaluation = FALSE”

The addresses to be invited which are reported back are determined by the second conference server (e.g. PoC server) PS2 218 in a similar or identical manner as by the first conference server 206 in the first communication network N1 202. Thus, the second conference server PS2 218, for example, first requests from the second shared-profile XML document management server SPX2 308 of its communication network (e.g. the second communication network N2 204) the users in the second communication network N2 204 who are interested in football and then requests location information for the users interested in football from the second presence server PRS2 306 of its communication network (e.g. the second communication network N2 204).

In detail, this is done, for example, by the second conference server PS2 218, after receiving the further conference session invitation message 818, generating a second user terminal address request message 820 (e.g. a second XCAP GET message 820) (which contains the conditions (in the present example the condition “hobbies=football”)) and conveying it to the second shared-profile XML document management server SPX2 308. The second shared-profile XML document management server SPX2 308 determines those users or their user terminals (for example in the form of their user terminal addresses) which meet the received conditions. The second shared-profile XML document management server SPX2 308 then generates a second user terminal address response message 822 which contains the determined user terminal addresses which meet the conditions (for example in the form of a second XCAP OK message 822 which contains the determined user terminal addresses) and conveys it to the second conference server PS2 218.

The second conference server PS2 218 then sends this received list of determined user terminal addresses to the second presence server PRS2 306 of the second communication network N2 204 and by this means requests location information (as an example of availability information) about the users contained in the received list. In one illustrative embodiment this is done by the second conference server PS2 218, after receiving the second user terminal address response message 822, determining the user terminal addresses contained therein and generating a second availability information request message 824, the second availability information request message 824 containing at least a part of the (for example all of the) determined user terminal addresses, and conveying these to the second presence server PRS2 306. In one illustrative embodiment, the second availability information request message 824 is a second SIP SUBSCRIBE message 824.

It should be pointed out that the determination of the location areas of the users or their user terminals, respectively, can also take place before or at the same time as the determination of the users or their user terminals, respectively, which meet the conditions with regard to the information stored in the second shared-profile XML document management server SPX2 308.

The second presence server PRS2 306 determines the location information for the user terminal addresses contained in the second availability information request message 824 received by it. It then generates a second availability information response message 826 which contains the determined location information and conveys this to the second conference server PS2 218. In one illustrative embodiment, the second availability information response message 826 is a second SIP NOTIFY message 826.

After receiving the second availability information response message 826, the second conference server PS2 218 checks the determined location information and determines all users or their user terminals, respectively, which are staying in Munich. These users or their user terminals, respectively, are temporarily stored by the second conference server PS2 218 in a memory (not shown).

The second conference server PS2 218 then invites the users determined by it which meet the conditions to the conference session by means of further conference session invitation messages (it is assumed in this example that the third user T3 or his third user terminal 220, respectively, and the fourth user T4 or his fourth user terminal 224, respectively, meet the conditions), for example by the second conference server PS2 218 generating a first further conference session invitation message 828 and conveying it to the third user T3 or his third user terminal 220, respectively, and by it generating a second further conference session invitation message 832 and conveying it to the fourth user T4 or his fourth user terminal 224, respectively. In one illustrative embodiment, the further conference session invitation messages 828, 832 are SIP INVITE messages 828, 832.

It is also assumed in this example that the third user T3 or his third user terminal 220, respectively, and the fourth user T4 or his fourth user terminal 224, respectively, wish to participate in the conference to which they have been invited. The third user terminal 220 thus generates a second invitation acceptance message 830 and conveys it to the second conference server PS2 218. In one illustrative embodiment, the second invitation acceptance message 830 is an SIP 200 OK message 830. Furthermore, the fourth user terminal 224 generates a third invitation acceptance message 834 and conveys it to the second conference server PS2 218. In one illustrative embodiment, the third invitation acceptance message 834 is an SIP 200 OK message 834.

As soon as at least one user invited by the second conference server PS2 218 has accepted the invitation, the second conference server PS2 218 notifies the first conference server PS1 206 that its invitation was successful. According to one illustrative embodiment this is done by the second conference server PS2 218, after receiving the second invitation acceptance message 830 and/or the third invitation acceptance message 824, generating a fourth invitation acceptance message 836 and conveying it to the first conference server PS1 206. In one illustrative embodiment, the fourth invitation acceptance message 836 has in its message body the user terminal addresses of the user terminals which have accepted the invitation to the conference and meet the conditions (thus, for example, the user terminal addresses of the third user terminal 220 and of the fourth user terminal 224) and the fourth invitation acceptance message 836 is only sent out when all users invited by the second conference server PS2 218 have accepted the invitation.

The conference session can now be established between all user terminals which accept the invitation to the conference session.

It should be pointed out that the conference session invitation message 818 for inviting users from the second network N2 204 can also be sent out before or at the same time as the XCAP GET message 804 or the availability information request message 808.

According to one illustrative embodiment, if the condition(s) was (were) not met at the time of the invitation, the respective communication server PS1 206, PS2 218 optionally checks the condition(s) again later. As soon as the condition(s) is or are met, the first communication server PS1 206 and/or the second communication server PS2 218 invites the users to a conference session.

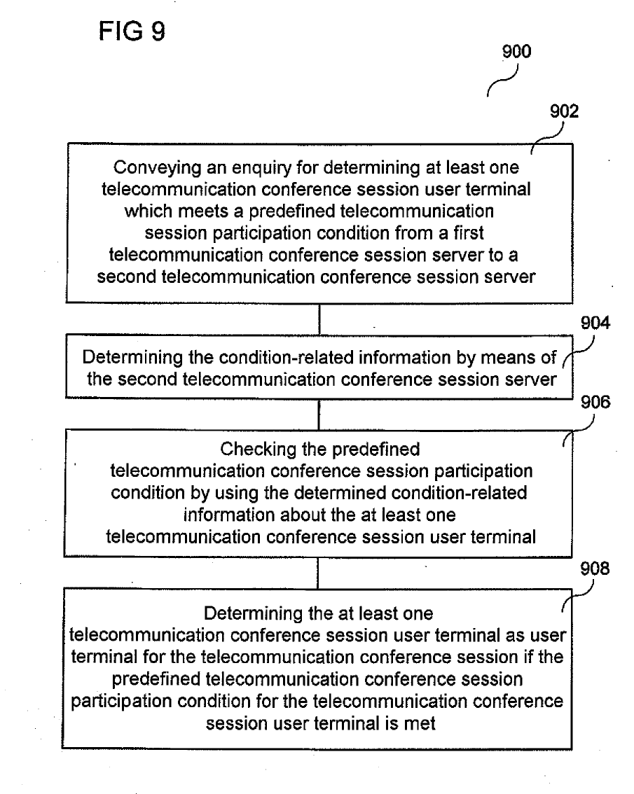

FIG. 9 shows a flowchart 900 in which a method according to another illustrative embodiment is shown.

In the method for determining at least one user terminal for a telecommunication conference session with a multiplicity of telecommunication conference session user terminals according to the present illustrative embodiment, a predefined telecommunication conference session participation condition is allocated to the at least one telecommunication conference session user terminal.

In 902, an enquiry for determining at least one telecommunication conference session user terminal which meets a predefined telecommunication conference session participation condition is conveyed from a first telecommunication conference session server to a second telecommunication conference session server.

In 904, a condition-related information item is determined by means of the second telecommunication conference session server.

In 906, the predefined telecommunication conference session participation condition is checked by using the determined condition-related information about the at least one telecommunication conference session user terminal.

In 908, the at least one telecommunication conference session user terminal is determined as user terminal for the telecommunication conference session if the predefined telecommunication conference session participation condition for the telecommunication conference session user terminal is met.

Various illustrative embodiments enable dynamic communication groups to be implemented over several communication networks. For example, hierarchical dynamic communication groups are also made possible over several communication networks.

According to various illustrative embodiments, conditions for dynamic communication groups are checked by several conference servers. The several conference servers may belong to several different communication networks (with the same or different communication network operators). The dynamic communication groups can be hierarchical communication groups.

To check conditions for the membership of communication users to a dynamic communication group, the central conference server sends the conditions to other conference servers. The other conference servers check the conditions for users who are served by these conference servers. Subsequently, the further conference servers report users who meet the conditions to the central conference server. The central conference server can then invite these users to the communication conference session.

In one illustrative embodiment, the further conference servers report the found users once to the central conference server. In another illustrative embodiment, the further conference servers report found users several times, for example when new users have been found or when old users no longer meet the conditions.

Illustrative embodiments may be implemented with the aid of SIP INVITE messages and SIP SUBSCRIBE/NOTIFY messages.

In various illustrative embodiments, the work for checking conditions does not have to be carried out by a single conference server. This relieves the central conference server of checkings.

In various illustrative embodiments, the further conference servers only need to be authorized for calling up relevant information about users of their communication network. It is not necessary that all conference servers of all communication networks are authorized to call up information from all communication networks.

If the location of one of the friends changes (either is now Munich and previously was not Munich or conversely), the second presence server PRS2 504 reports this to the second conference server (e.g. PoC server) PS2 218 in the second communication network N2 204 by SIP NOTIFY message. The second conference server PS2 218 then reports this to the first conference server PS1 206 by SIP NOTIFY message. The first conference server PS1 206 forwards the SIP NOTIFY message to the first user T1 or his first user terminal 210, respectively.

If it is reported back for a user (e.g. PoC user) that he now meets the condition of the dynamic group, he is automatically invited to the communication conference session by the first user T1 through the communication terminal. If it is reported back for a user (e.g. PoC user) that he no longer meets the condition of the dynamic group, he is automatically removed from the communication conference session by the first user T1 through the communication terminal.

Instead of requesting relevant addresses from other networks by SIP INVITE message as in the example described with reference to FIG. 3 and FIG. 4, these addresses may also be requested by SIP SUBSCRIBE message from the other (e.g. second) conference server (PoC server) PS2 218 by the central first conference server (e.g. PoC server) PS1 206, even if the triggering SIP message from the first user terminal 210 of the first user T1 was an SIP INVITE message. This is appropriate, for example, if conditions are to be checked again.

Conditions may also be repeatedly checked in other communication networks by repeated SIP INVITE messages by the central first conference server (e.g. PoC server) PS1 206.

If a communication user invites a dynamic group to a communication conference session by SIP INVITE message, it may also be provided that this user is automatically subscribed for the dynamic group. The user then automatically receives notifications about joining or dropped members of the dynamic group.

Instead of automatically performing changes in the conference session after repeated checking of the conditions of a dynamic group, it may also be provided to ask the inviting user before a change whether this change is to be carried out.

The search for relevant members of a dynamic group may be restricted by the communication network operator. For example, it may be provided that the number of members of a dynamic group must not exceed a particular value or that the search for members is only carried out in particular communication networks (e.g. only in the communication network of the inviting user).

If conditions for dynamic groups are both defined in the group management server and are established by SIP INVITE message or by SIP SUBSCRIBE message on session initiation, it may be provided either to use both sets of conditions together or to use one of the sets and to ignore the other one.

Instead of using SIP INVITE messages or SIP SUBSCRIBE/NOTIFY messages for requesting addresses or conditions, the request can also be made with a special new SIP message which is defined especially for this purpose or can be used for it.

Instead of using SIP for conference session invitations and enquiries, other protocols can also be used, for example those described above.

It should be pointed out that the illustrative embodiments are not restricted to PoC systems but that they can also be used in other PTT systems or generally in other conference systems.

According to one illustrative embodiment, a method for determining at least one user terminal for a telecommunication conference session with a multiplicity of telecommunication conference session user terminals is provided,

wherein a predefined telecommunication conference session participation condition is allocated to the at least one telecommunication conference session user terminal,

wherein an enquiry for determining at least one telecommunication conference session user terminal which meets the telecommunication conference session participation condition is conveyed by a first telecommunication conference session server to a second telecommunication conference session server,

wherein condition-related information is determined by means of the second telecommunication conference session server,

wherein the predefined telecommunication conference session participation condition is checked by using the determined condition-related information about the at least one telecommunication conference session user terminal, and

wherein the at least one telecommunication conference session user terminal is determined as user terminal for the telecommunication conference session if the predefined telecommunication conference session participation condition for the telecommunication conference session user terminal is met.

For example, the condition-related information item has or is a user terminal address.

For example, the condition-related information item is conveyed by the second telecommunication conference session server to a test circuit and the test circuit checks the predefined telecommunication conference session participation condition.

For example, the first telecommunication conference session server invites the at least one user terminal to the telecommunication conference session.

For example, the first telecommunication conference session server invites the at least one user terminal to the telecommunication conference session by conveying a telecommunication conference session invitation message to the at least one user terminal.

For example, the condition-related information item is conveyed to a telecommunication conference session user terminal inviting to the telecommunication conference session.

For example, a user terminal address of the at least one determined telecommunication conference session user terminal is conveyed as the condition-related information item to the telecommunication conference session user terminal inviting to the telecommunication conference session.

For example, a telecommunication conference session user terminal inviting to the telecommunication conference session invites the at least one user terminal to the telecommunication conference session by conveying a telecommunication conference session invitation message to the at least one user terminal.

For example, the second telecommunication conference session server invites the at least one user terminal to the telecommunication conference session.

For example, the second telecommunication conference session server invites the at least one user terminal to the telecommunication conference session by conveying a telecommunication conference session invitation message to the at least one user terminal.

According to one embodiment, a telecommunication conference arrangement for determining at least one user terminal for a telecommunication conference session with a multiplicity of telecommunication conference session user terminals is provided,

wherein a predefined telecommunication conference session participation condition is allocated to the at least one telecommunication conference session user terminal,

with a first telecommunication conference session server which may include:
an enquiry generating circuit configured to generate an enquiry for determining at least one telecommunication conference session user terminal which meets the telecommunication conference session participation condition,
a transmitter configured to transmit the enquiry to a second telecommunication conference session server,

with a second telecommunication conference session server which may include:
a receiver configured to receive the enquiry from the first telecommunication conference session server,
a determination circuit configured to determine the condition-related information item,

with a test circuit which is configured to check the telecommunication conference session participation condition by using the determined condition-related information item about the at least one telecommunication conference session user terminal,

with a user terminal determination circuit which is configured to determine the at least one telecommunication conference session user terminal as user terminal for the telecommunication conference session if the telecommunication conference session participation condition for the telecommunication conference session user terminal is met.

For example, the at least one telecommunication conference session user terminal is allocated to a user terminal group.

For example, the user terminal group is identified by means of a telecommunication conference session user group identification.

For example, the telecommunication conference arrangement includes a telecommunication conference session set-up circuit configured to set up the telecommunication conference session with the determined at least one telecommunication conference session user terminal.

For example, the first telecommunication conference session server and the second telecommunication conference session server are set up for communication according to a half-duplex telecommunication conference session.

For example, the first telecommunication conference session server and the second telecommunication conference session server are configured to communicate according to a push-to-talk telecommunication conference session.

For example, the first telecommunication conference session server and the second telecommunication conference session server are configured to communicate according to a Push-to-Talk over Cellular telecommunication conference session.

For example, the first telecommunication conference session server and the second telecommunication conference session server are configured to communicate according to an Internet-based telecommunication conference session.

For example, the first telecommunication conference session server and the second telecommunication conference session server are configured to set up the telecommunication conference session by using at least one telecommunication conference control message according to a telecommunication conference control protocol.

For example, the telecommunication conference control protocol is a protocol of the following protocols:

Session Initiation Protocol,

Real Time Transport Control Protocol,

Binary Floor Control Protocol.

For example, the first telecommunication conference session server and the second telecommunication conference session server are configured to set up the telecommunication conference session by using at least one Session Initiation Protocol INVITE message and/or at least one Session Initiation Protocol SUBSCRIBE/NOTIFY message as telecommunication conference control message.

For example, the first telecommunication conference session server and the second telecommunication conference session server are arranged in different telecommunication networks.

For example, the telecommunication conference session user group identification identifies a multiplicity of telecommunication conference session user terminals grouped to form the user group.

For example, the group identified by means of the telecommunication conference session user group identification has an additional telecommunication conference session user group identification which identifies at least one additional telecommunication conference session user terminal.

For example,

the first telecommunication conference session server further includes an enquiry-message-generating circuit configured to generate an enquiry message, the enquiry message including an enquiry for availability information of the at least one telecommunication conference session user terminal,

the transmitter of the first telecommunication conference session server is configured to transmit the enquiry message to a presence server which is arranged in the same telecommunication network as the first telecommunication conference session server.

For example, the telecommunication conference arrangement has a presence server which is arranged in the same telecommunication network as the first telecommunication conference session server.

For example, the telecommunication conference session user group identification is a telecommunication conference session user group address.

For example, the telecommunication conference session user group address has the same structural configuration as a telecommunication conference session user terminal address identifying a single telecommunication conference session user terminal.

For example, the condition-related information item has at least one personal information item about a user of a user terminal.

For example, the condition-related information item has at least one of the following information items:

an information item about interests of a user of a user terminal,

an information item about the gender of a user of a user terminal,

an information item about the age of a user of a user terminal,

an information item about a profession of a user of a user terminal,

an information item about a spatial location area of at least one telecommunication conference session user terminal.

For example, the first telecommunication conference session server also has a receiver configured to receive the condition-related information.

For example, the condition-related information includes a user terminal address or is a user terminal address.

For example, the telecommunication conference arrangement includes a test circuit which is configured to check the predefined telecommunication conference session participation condition.

For example, the first telecommunication conference session server is configured in such a manner that it invites the at least one user terminal to the telecommunication conference session.

For example, the first telecommunication conference session server is configured in such a manner that it invites the at least one user terminal to the telecommunication conference session by conveying a telecommunication conference session invitation message to the at least one user terminal.

For example, the telecommunication conference arrangement includes a telecommunication conference session user terminal inviting to the telecommunication conference session.

For example, the telecommunication conference session user terminal inviting to the telecommunication conference session is arranged for receiving condition-related information.

For example, the telecommunication conference session user terminal inviting to the telecommunication conference session is configured to receive condition-related information, wherein the condition-related information has or is a user terminal address of the at least one determined telecommunication conference session user terminal.

For example, the second telecommunication conference session server is configured in such a manner that it invites the at least one user terminal to the telecommunication conference session.

For example, the second telecommunication conference session server is configured in such a manner that it invites the at least one user terminal to the telecommunication conference session by conveying a telecommunication conference session invitation message to the at least one user terminal.

According to one illustrative embodiment, a telecommunication conference session server for determining at least one user terminal for a telecommunication conference session with a multiplicity of telecommunication conference session user terminals may be provided,

wherein a predefined telecommunication conference session participation condition is allocated to the at least one telecommunication conference session user terminal,

an enquiry generating circuit configured to generate an enquiry for determining at least one telecommunication conference session user terminal which meets the telecommunication conference session participation condition, and

a transmitter configured to transmit the enquiry to another telecommunication conference session server.

For example, the at least one telecommunication conference session user terminal is allocated to a user terminal group.

For example, the user terminal group is identified by means of a telecommunication conference session user group identification.

For example, the telecommunication conference session server may include a telecommunication conference session set-up circuit configured to set up the telecommunication conference session with the determined at least one telecommunication conference session user terminal.

For example, the telecommunication conference session server is configured to communicate according to a half-duplex telecommunication conference session.

For example, the telecommunication conference session server is configured to communicate according to a push-to-talk telecommunication conference session.

For example, the telecommunication conference session server is configured to communicate according to a Push-to-Talk over Cellular telecommunication conference session.

For example, the telecommunication conference session server is configured to communicate according to an internet-based telecommunication conference session.

For example, the telecommunication conference session server is configured to set up the telecommunication conference session by using at least one telecommunication conference control message according to a telecommunication conference control protocol.

For example, the telecommunication conference control protocol is a protocol of the following protocols:

Session Initiation Protocol,

Real Time Transport Control Protocol,

Binary Floor Control Protocol.

For example, the telecommunication conference session server is configured to set up the telecommunication conference session by using at least one Session Initiation Protocol INVITE message and/or at least one Session Initiation Protocol SUBSCRIBE/NOTIFY message as telecommunication conference control message.

For example, the telecommunication conference session user group identification identifies a multiplicity of telecommunication conference session user terminals grouped to form the user group.

For example, the group identified by means of the telecommunication conference session user group identification includes an additional telecommunication conference session user group identification which identifies at least one additional telecommunication conference session user terminal.

For example, the telecommunication conference session server includes an enquiry-message-generating circuit configured to generate an enquiry message, wherein the enquiry message includes an enquiry for availability information of the at least one telecommunication conference session user terminal, and the transmitter is configured to transmit the enquiry message to a presence server which is arranged in the same telecommunication network as the first telecommunication conference session server.

For example, the telecommunication conference session user group identification is a telecommunication conference session user group address.

For example, the telecommunication conference session user group address has the same structural configuration as a telecommunication conference session user terminal address identifying a single telecommunication conference session user terminal.

For example, the condition-related information has at least one personal information item about a user of a user terminal.

For example, the condition-related information has at least one of the following information items:

an information item about interests of a user of a user terminal,

an information item about the gender of a user of a user terminal,

an information item about the age of a user of a user terminal,

an information item about a profession of a user of a user terminal,

an information item about a spatial location area of at least one telecommunication conference session user terminal.

For example, the telecommunication conference session server has a receiver for receiving the condition-related information item.

For example, the condition-related information item has a user terminal address or is a user terminal address.

For example, the telecommunication conference session server has a user terminal determination circuit which is configured to determine the at least one telecommunication conference session user terminal as user terminal for the telecommunication conference session if the predefined telecommunication conference session participation condition for the telecommunication conference session user terminal is met.

For example, the telecommunication conference session server is configured in such a manner that it invites the at least one user terminal to the telecommunication conference session.

For example, the telecommunication conference session server is configured in such a manner that it invites the at least one user terminal to the telecommunication conference session by conveying a telecommunication conference session invitation message to the at least one user terminal.

According to one embodiment, a telecommunication conference session server for determining at least one user terminal for a telecommunication conference session with a multiplicity of telecommunication conference session user terminals may be provided,

wherein a predefined telecommunication conference session participation condition is allocated to the at least one telecommunication conference session user terminal,

with a receiver configured to receive an enquiry for determining at least one telecommunication conference session user terminal which meets the telecommunication conference session participation condition from another telecommunication conference session server, and

with a determination circuit configured to determine the at least one telecommunication conference session user terminal.

For example, the at least one telecommunication conference session user terminal is allocated to a user terminal group.

For example, the user terminal group is identified by means of a telecommunication conference session user group identification.

For example, the telecommunication conference session server is configured to communicate according to a half-duplex telecommunication conference session.

For example, the telecommunication conference session server is configured to communicate according to a push-to-talk telecommunication conference session.

For example, the telecommunication conference session server is configured to communicate in accordance with a Push-to-Talk over Cellular telecommunication conference session.

For example, the telecommunication conference session server is configured to communicate according to an Internet-based telecommunication conference session.

For example, the telecommunication conference session server is configured to set up the telecommunication conference session by using at least one telecommunication conference control message according to a telecommunication conference control protocol.

For example, the telecommunication conference control protocol is a protocol of the following protocols:

Session Initiation Protocol,

Real Time Transport Control Protocol,

Binary Floor Control Protocol.

For example, the telecommunication conference session server is configured to set up the telecommunication conference session by using at least one Session Initiation Protocol INVITE message and/or at least one Session Initiation Protocol SUBSCRIBE/NOTIFY message as telecommunication conference control message.

For example, the telecommunication conference session user group identification identifies a multiplicity of telecommunication conference session user terminals grouped to form the user group.

For example, the group identified by means of the telecommunication conference session user group identification has an additional telecommunication conference session user group identification which identifies at least one additional telecommunication conference session user terminal.

For example, the telecommunication conference session user group identification is a telecommunication conference session user group address.

For example, the telecommunication conference session user group address has the same structural configuration as a telecommunication conference session user terminal address identifying a single telecommunication conference session user terminal.

For example, the condition-related information has at least one personal information item about a user of a user terminal.

For example, the condition-related information has at least one of the following information items:

an information item about interests of a user of a user terminal,

an information item about the gender of a user of a user terminal,

an information item about the age of a user of a user terminal,

an information item about a profession of a user of a user terminal,

an information item about a spatial location area of at least one telecommunication conference session user terminal.

For example, the telecommunication conference session server includes a transmitter configured to transmit the condition-related information item to a test circuit which is configured to check the predefined telecommunication conference session participation condition.

For example, the telecommunication conference session server is configured in such a manner that it invites the at least one user terminal to the telecommunication conference session.

For example, the telecommunication conference session server is configured in such a manner that it invites the at least one user terminal to the telecommunication conference session by conveying a telecommunication conference session invitation message to the at least one user terminal.

According to one embodiment, a method for determining at least one user terminal for a telecommunication conference session with a multiplicity of telecommunication conference session user terminals is provided,

wherein a predefined telecommunication conference session participation condition is allocated to the at least one telecommunication conference session user terminal,

wherein the predefined telecommunication conference session participation condition is checked by including two telecommunication conference session servers,

wherein a first telecommunication conference session server receives an enquiry for determining at least one user terminal for a telecommunication conference session, and

wherein a second telecommunication conference session server determines condition-related information for determining the user terminal which meets the predefined telecommunication conference session participation condition.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for determining at least one user terminal for a telecommunication conference session with a multiplicity of telecommunication conference session user terminals, the method comprising:
allocating a predefined telecommunication conference session participation condition to the at least one telecommunication conference session user terminal;
conveying an enquiry for determining at least one telecommunication conference session user terminal which meets the telecommunication conference session participation condition from a first telecommunication conference session server to a second telecommunication conference session server;
determining condition-related information by means of the second telecommunication conference session server;
checking the predefined telecommunication conference session participation condition by using the determined condition-related information about the at least one telecommunication conference session user terminal; and
determining the at least one telecommunication conference session user terminal as user terminal for the telecommunication conference session if the predefined telecommunication conference session participation condition for the telecommunication conference session user terminal is met.

2. The method according to claim 1,
wherein the at least one telecommunication conference session user terminal is allocated to a user terminal group.

3. The method according to claim 2,
wherein the user terminal group is identified by means of a telecommunication conference session user group identification.

4. The method according to claim 1,
wherein the telecommunication conference session is set up with the determined at least one telecommunication conference session user terminal.

5. The method according to claim 1,
wherein the telecommunication conference session is a half-duplex telecommunication conference session.

6. The method according to claim 5,
wherein the telecommunication conference session is a push-to-talk telecommunication conference session.

7. The method according to claim 6,
wherein the telecommunication conference session is a Push-to-Talk over Cellular telecommunication conference session.

8. The method according to claim 1,
wherein the telecommunication conference session is an Internet-based telecommunication conference session.

9. The method according to claim 4,
wherein the telecommunication conference session is set up by using at least one telecommunication conference control message according to a telecommunication conference control protocol.

10. The method according to claim 9,
wherein the telecommunication conference control protocol is a protocol selected from a group of protocols consisting of:
Session Initiation Protocol;
Real Time Transport Control Protocol; and
Binary Floor Control Protocol.

11. The method according to claim 9,
wherein the telecommunication conference session is set up by using at least one message selected from a group of messages consisting of:
at least one Session Initiation Protocol INVITE message; and
at least one Session Initiation Protocol SUBSCRIBE/NOTIFY message as telecommunication conference control message.

12. The method according to claim 1,
wherein the first telecommunication conference session server and the second telecommunication conference session server are arranged in different telecommunication networks.

13. The method according to claim 3,
wherein the telecommunication conference session user group identification identifies a multiplicity of telecommunication conference session user terminals grouped to form the user group.

14. The method according to claim 13,
wherein a predefined telecommunication conference session participation condition is allocated to several telecommunication conference session user terminals.

15. The method according to claim 1,
wherein the group identified by means of the telecommunication conference session user group identification comprises an additional telecommunication conference session user group identification which identifies at least one additional telecommunication conference session user terminal.

16. The method according to claim 1,
wherein an enquiry for availability information of the at least one telecommunication conference session user terminal is sent to a presence server which is arranged in a different telecommunication network from the first telecommunication conference session server.

17. The method according to claim 1,
wherein the telecommunication conference session user group identification is a telecommunication conference session user group address.

18. The method according to claim 17,
wherein the telecommunication conference session user group address has the same structural configuration as a telecommunication conference session user terminal address identifying a single telecommunication conference session user terminal.

19. The method according to claim 1,
wherein the condition-related information comprises at least one personal information item about a user of a user terminal.

20. The method according to claim 1,
wherein the condition-related information item comprises at least one of the following information items:
an information item about interests of a user of a user terminal;
an information item about the gender of a user of a user terminal;
an information item about the age of a user of a user terminal;
an information item about a profession of a user of a user terminal;
an information item about a spatial location area of at least one telecommunication conference session user terminal.

21. The method according to claim 1,
wherein the condition-related information item is conveyed to the first telecommunication conference session server.

22. A telecommunication conference session server for determining at least one user terminal for a telecommunication conference session with a multiplicity of telecommunication conference session user terminals,
wherein a predefined telecommunication conference session participation condition is allocated to the at least one telecommunication conference session user terminal,
the telecommunication conference session server comprising:
an enquiry generating circuit configured to generate an enquiry for determining at least one telecommunication conference session user terminal which meets the telecommunication conference session participation condition, and
a transmitter configured to transmit the enquiry to another telecommunication conference session server.

23. A method for generating an enquiry for determining at least one user terminal for a telecommunication conference session with a multiplicity of telecommunication conference session user terminals,
wherein a predefined telecommunication conference session participation condition is allocated to the at least one telecommunication conference session user terminal,
the method comprising:
a telecommunication conference session server generating an enquiry for determining at least one telecommunication conference session user terminal which meets the telecommunication conference session participation condition.

24. A telecommunication conference session server for determining at least one user terminal for a telecommunication conference session with a multiplicity of telecommunication conference session user terminals,
wherein a predefined telecommunication conference session participation condition is allocated to the at least one telecommunication conference session user terminal,
the telecommunication conference session server comprising:
a receiver configured to receive an enquiry for determining at least one telecommunication conference session user terminal which meets the telecommunication conference session participation condition from another telecommunication conference session server, and
a determination circuit configured to determine the at least one telecommunication conference session user terminal.

25. A method for determining a condition-related information item for determining at least one user terminal for a telecommunication conference session with a multiplicity of telecommunication conference session user terminals,
wherein a predefined telecommunication conference session participation condition is allocated to the at least one telecommunication conference session user terminal;
the method comprising:
receiving an enquiry for determining at least one telecommunication conference session user terminal which meets the telecommunication conference session participation condition by another telecommunication conference session server; and
determining the condition-related information item by a telecommunication conference session server receiving the enquiry.
